(19) United States
(12) Patent Application Publication
(10) Pub. No.: US 2015/0155917 A1
(43) Pub. Date: Jun. 4, 2015

(54) METHOD AND DEVICE FOR CONNECTING AND INTERACTING WITH ELECTRONIC DEVICES USING PROTECTIVE COVER OF ELECTRONIC DEVICE

(71) Applicant: Samsung Electronics Co., Ltd., Gyeonggi-do (KR)

(72) Inventor: Sung-Joon WON, Gyeonggi-do (KR)

(73) Assignee: Samsung Electronics Co., Ltd.

(21) Appl. No.: 14/560,320

(22) Filed: Dec. 4, 2014

(30) Foreign Application Priority Data
Dec. 4, 2013 (KR) 10-2013-0149925

(51) Int. Cl. H04B 5/00; H04B 1/03

(52) U.S. Cl. CPC H04B 5/0031; H04B 1/03

(57) ABSTRACT

A method and device for a connection and an interaction between electronic devices using a protective cover of an electronic device are provided. The method of operating a second electronic device for an interaction between electronic devices includes detecting a communication module of a plurality of communication module included in a protective cover, the protective cover being used to protect a first electronic device; receiving information about the first electronic device from the communication module of the detected protective cover; and performing an interaction with the first electronic device using the information about the first electronic device.

### PRIORITY

This application claims priority under 35 U.S.C. §119(a) to Korean Patent Application Serial No. 10-2013-0149925, filed in the Korean Intellectual Property Office on Dec. 4, 2013, the entire content of which is incorporated herein by reference.

### BACKGROUND OF THE INVENTION

1. Field of the Invention

The present invention generally relates to a protective cover of an electronic device.

2. Description of the Related Art

Nowadays, an electronic device such as a smart phone has been widely used, and such a smart phone is a precise device having integrated various functions. When an external impact or vibration is transferred to the smart phone, the smart phone may erroneously operate. Further, when the smart phone drops from a user's hand to a floor, the smart phone may be scratched or even damaged.

In order to protect the smart phone from an external impact or vibration, a protective cover may be mounted in the smart phone. As the protective cover is made of an elastic material and contacts with the outside of the smart phone, the protective cover can protect the smart phone.

FIGS. 1A, 1B and 1C illustrate a protective cover of an electronic device in the conventional art.

FIG. 1A illustrates a state in which a protective cover in a diary form is closed (i.e., a smart phone is covered). FIG. 1B illustrates a state in which a protective cover is half-opened. FIG. 1C illustrates a state in which a protective cover is completely opened. The smart phone may be mounted on any one inside surface (a left inside surface or a right inside surface) of a protective cover in a diary form. Further, a front piece of the protective cover in a diary form may be moved so to control the protective cover when being opened or closed.

As described above, most protective covers are mainly used for protecting a smart phone from an external impact or vibration. Other functions in addition to the protecting function are added by the manufacturer. For example, by forming a transparent window at a front surface of a front piece of the protective cover, a time, a date, a call received during absence of the user of a smart phone, and antenna and battery state information may be displayed through the transparent window. The user may receive and transmit a call without opening the protective cover.

Therefore, a method and device for supporting various functions using a protective cover in an electronic device are needed.

### SUMMARY OF THE INVENTION

The present invention has been made to solve at least the above-mentioned problems and/or disadvantages and to provide at least the advantages described below. Accordingly, an aspect of the present invention is to provide a method and device for a connection and an interaction between electronic devices using a protective cover including at least one Near Field Communication (NFC) module of an electronic device.

Another aspect of the present invention is to provide a method and device for sharing data or a screen of a first electronic device and a second electronic device using an inner surface of a protective cover of the first electronic device.

In accordance with an aspect of the present invention, a method of operating a second electronic device for an interaction between electronic devices is provided, which includes detecting a communication module of at least one communication module included in a protective cover, the protective cover being used to protect a first electronic device; receiving information about the first electronic device from the detected communication module of the protective cover; and performing an interaction with the first electronic device based on the information about the first electronic device.

In accordance with another aspect of the present invention, a method of operating a first electronic device for an interaction between electronic devices is provided, which includes receiving information representing whether a second electronic device contacts with a protective cover from a communication module of at least one communication module included in the protective cover, the protective cover being used to protect the first electronic device; and preparing an interaction with the second electronic device.

In accordance with another aspect of the present invention, a second electronic device for an interaction between electronic devices is provided, which includes a processor configured to detect a communication module of at least one communication module included in a protective cover the protective cover being used to protect a first electronic device, to receive information about the first electronic device from the detected communication module of the protective cover, and to perform an interaction with the first electronic device based on the information about the first electronic device.

In accordance with another aspect of the present invention, a first electronic device for an interaction between electronic devices is provided, which includes a processor configured to receive information representing whether a second electronic device contacts with a protective cover from at least one communication module of a plurality of communication modules included in the protective cover, the protective cover being used to protect the first electronic device, and to prepare an interaction with the second electronic device.

### BRIEF DESCRIPTION OF THE DRAWINGS

The above and other aspects, features and advantages of certain embodiments of the present invention will be more apparent from the following detailed description, taken in conjunction with the accompanying drawings, in which:

FIGS. 1A, 1B and 1C illustrate a cover of an electronic device in the conventional art;

FIGS. 2A and 2B illustrate an example of using the inside of a protective cover of an electronic device according to an embodiment of the present invention;

FIGS. 3A, 3B and 3C illustrate an example of using the inside of a protective cover of an electronic device according to an embodiment of the present invention;

FIGS. 4A and 4B illustrate an example of using the inside of a protective cover of an electronic device according to an embodiment of the present invention;

FIG. 5 illustrates a protective cover including an NFC module of an electronic device according to an embodiment of the present invention;

FIG. 6 illustrates a protective cover including an NFC module of an electronic device according to an embodiment of the present invention;

FIGS. 7A-7C illustrate a connection between a first electronic device and a second electronic device through a protective cover including an NFC module according to an embodiment of the present invention;

FIGS. 8A-8C illustrate an example of sharing data of a second electronic device through a connection between a first electronic device and the second electronic device using a protective cover including an NFC module according to an embodiment of the present invention;

FIGS. 9A-9C illustrate an example of sharing a screen of a second electronic device through a connection between a first electronic device and the second electronic device using a protective cover including an NFC module according to an embodiment of the present invention;

FIGS. 10A-10C illustrate an example of sharing data of a first electronic device through a connection between the first electronic device and a second electronic device using a protective cover including an NFC module according to an embodiment of the present invention;

FIGS. 11A-11C illustrate an example of sharing a screen of a first electronic device through a connection between the first electronic device and a second electronic device using a protective cover including an NFC module according to an embodiment of the present invention;

FIGS. 12A-12C illustrate screens for initial setup between a first electronic device and a protective cover including an NFC module according to an embodiment of the present invention;

FIGS. 13A and 13B illustrate a process that sets an NFC module of a protective cover according to an embodiment of the present invention;

FIGS. 14A and 14B illustrate a process that sets an NFC module of a protective cover according to an embodiment of the present invention;

FIGS. 15A-15C illustrate a protective cover including a plurality of NFC modules according to an embodiment of the present invention;

FIG. 16 illustrates a method of waking up a first electronic device according to an embodiment of the present invention;

FIG. 17 illustrates a method of waking up a first electronic device according to an embodiment of the present invention;

FIGS. 18A and 18B illustrate a processing example when at least two different second electronic devices are placed on a protective cover of a first electronic device according to an embodiment of the present invention;

FIGS. 19A and 19B illustrate a processing example when at least two different second electronic devices are placed on a protective cover of a first electronic device according to an embodiment of the present invention;

FIGS. 20A-20D illustrate an interaction between a first electronic device and a second electronic device through a connection between the first electronic device and the second electronic device using a protective cover according to an embodiment of the present invention;

FIGS. 21A and 21B illustrate an interaction between a first electronic device and a second electronic device through a connection between the first electronic device and the second electronic device using a protective cover according to an embodiment of the present invention;

FIG. 22 is a flowchart illustrating an operation of a second electronic device according to an embodiment of the present invention;

FIG. 23 is a flowchart illustrating an operation of a protective cover according to an embodiment of the present invention;

FIG. 24 is a flowchart illustrating an operation of a second electronic device according to an embodiment of the present invention;

FIG. 25 is a flowchart illustrating an operation of a first electronic device according to an embodiment of the present invention;

FIG. 26 is a flowchart illustrating an operation of a second electronic device according to an embodiment of the present invention;

FIG. 27 is a flowchart illustrating an operation of a first electronic device according to an embodiment of the present invention;

FIG. 28 is a flowchart illustrating an operation of a second electronic device according to an embodiment of the present invention;

FIG. 29 is a flowchart illustrating an operation of a first electronic device according to an embodiment of the present invention; and

FIG. 30 is a block diagram illustrating a configuration of an electronic device according to an embodiment of the present invention.

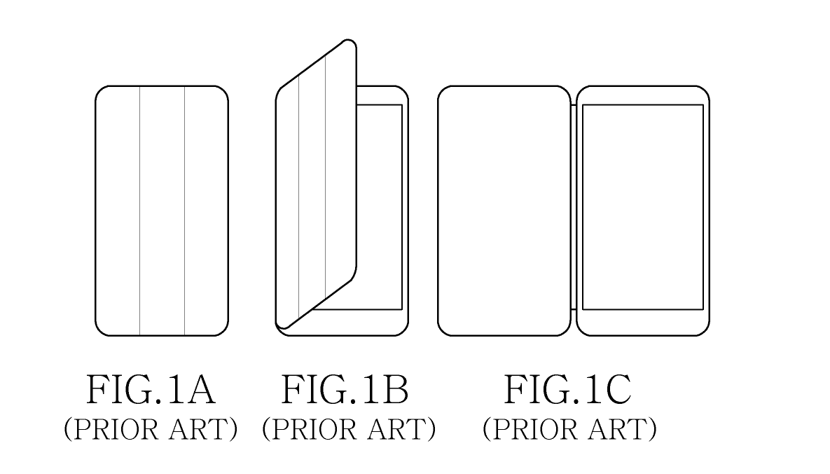

### DETAILED DESCRIPTION OF EMBODIMENTS OF THE PRESENT INVENTION

Hereinafter, embodiments of the present invention will be described with reference to the accompanying drawings. Detailed descriptions of well-known functions and structures incorporated herein may be omitted to avoid obscuring the subject matter of the present invention. The terms used herein are defined according to the functions of the present invention. Thus, the terms may vary depending on a user's or an operator's intension and usage. That is, the terms used herein should be understood based on the descriptions made herein.

Hereinafter, an embodiment of the present invention describes a method and device for a connection and an interaction between electronic devices using a protective cover of an electronic device. Specifically, when a second electronic device is tagged with one Near Field Communication (NFC) module of a plurality of NFC modules included in a protective cover of a first electronic device, a method and device for a connection between electronic devices and for sharing data or a screen of the first electronic device or the second electronic device are described.

An embodiment of the present invention describes a method of using an inner surface of a protective cover when a user opens the protective cover.

Hereinafter, a protective cover includes a front piece and a rear piece, and the inside surface of the protective cover has one side (e.g., left side) and another side (e.g., right side). For easy description, a left side of the inside surface of the protective cover is referred to as a left inside surface and is part of the front piece of the protective cover, and a right side of the inside surface of the protective cover is referred to as a right inside surface and is part of the rear piece of the protective cover. A first electronic device is an electronic device that contacts with one side of inside surface (e.g., right inside surface) of a protective cover so as to be attached to the one side of inside surface (e.g., right inside surface), and a second electronic device is an electronic device placed in a portion or the entire of the other side of inside surface (e.g., left inside surface) of a protective cover. Hereinafter, the protective cover is used to protect the first electronic device. Further, a protective cover including at least one NFC module may be referred to as a third electronic device. Further, the first electronic device may be physically connected to the third electronic device.

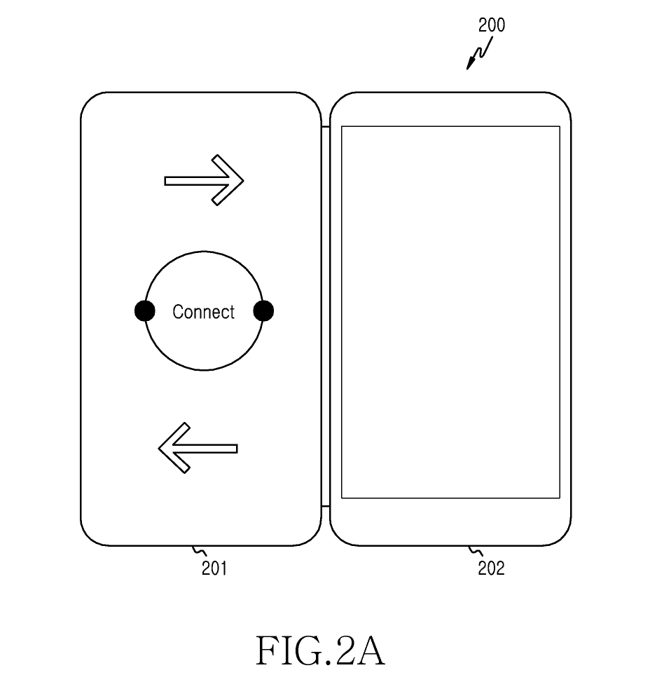

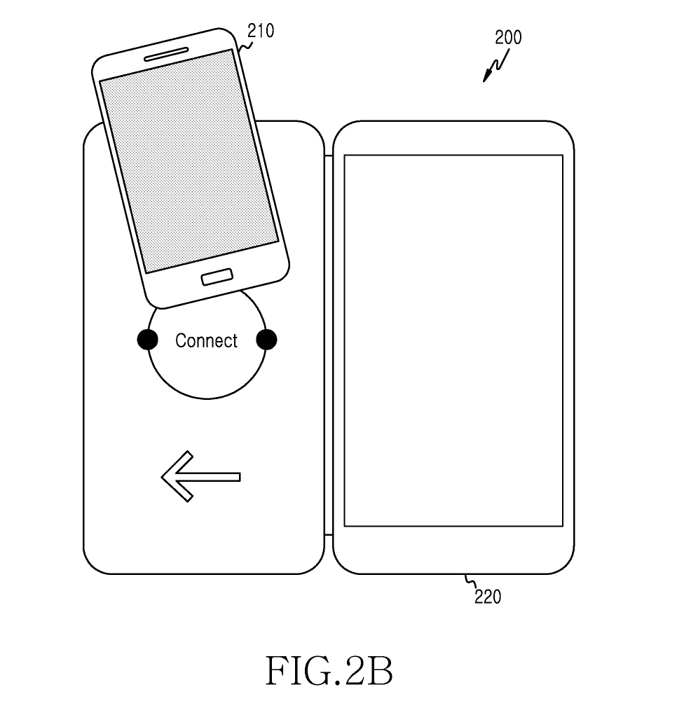

FIGS. 2A and 2B illustrate an example of using the inside of a protective cover of an electronic device according to an embodiment of the present invention.

FIG. 2A illustrates a protective cover 200 for a first electronic device, which is in a size of a tablet computer. Here, a left side piece of a protective cover 200 is a front piece and is referred to as a first piece 201, and a right side piece of a protective cover 200 is a rear piece and is referred to as a second piece 202. The first piece and the second piece are connected, and the first piece or the second piece may be moved so that the protective cover 200 can be folded or unfolded. Further, the first electronic device contacts with and is attached to the right inside surface, and at the left inside surface, an interface that controls a connection and an interaction between the second electronic device and the first electronic device may be provided.

FIG. 2B illustrates a case in which a second electronic device 210 smaller than the first electronic device is placed in a portion of the left inside surface of the protective cover 200 of FIG. 2A.

For example, when the second electronic device 210 is placed at a partial surface of the left inside surface, the second electronic device 210 may acquire information about the first electronic device 220 through an interface located at the left inside surface and may attempt a connection using information about the first electronic device 220 or may attempt to share a screen. For example, data or a screen of the first electronic device 220 may be shared with the second electronic device 210. Alternatively, data or a screen of the second electronic device 210 may be shared with the first electronic device 220.

In an embodiment of the present invention, in the protective cover 200, when the second electronic device 210 is placed at a partial surface of the left inside surface, the second electronic device 210 may be set to be an input device (e.g., a virtual keyboard) for the first electronic device. Alternatively, the first electronic device may be set to be an input device (e.g., a virtual keyboard) for the second electronic device 210.

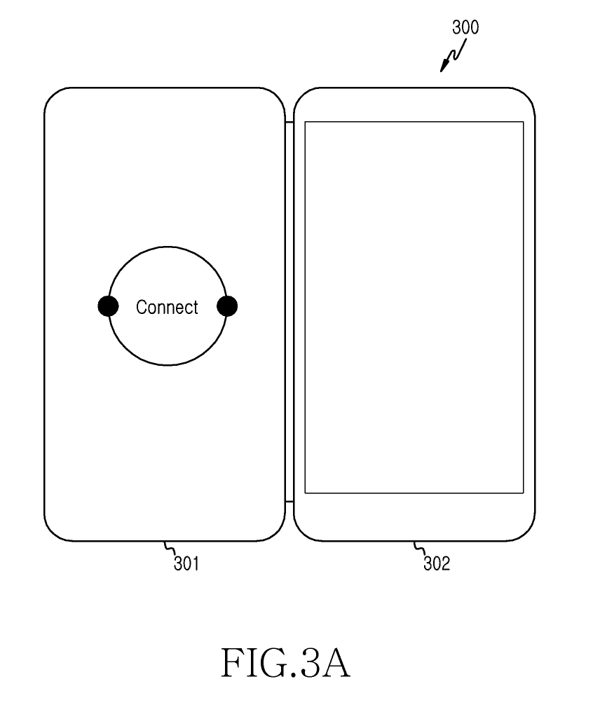

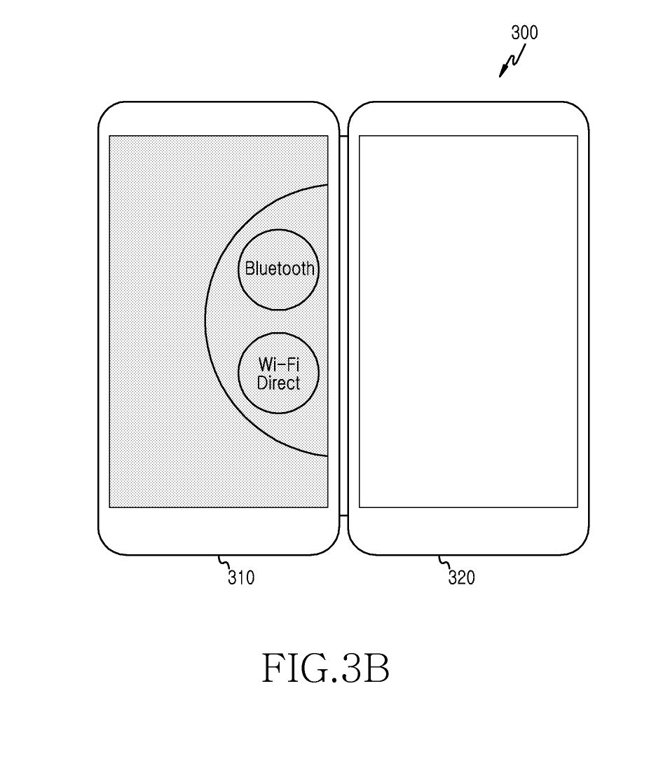

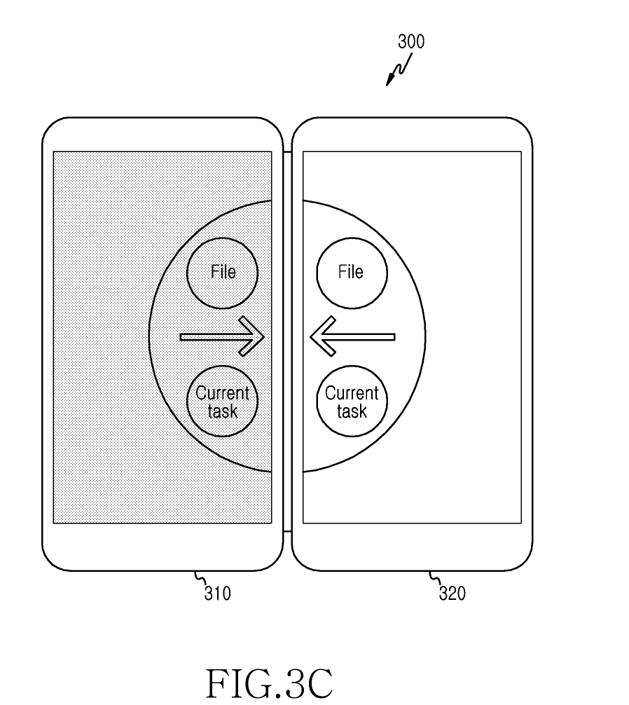

FIGS. 3A, 3B and 3C illustrate an example of using the inside of a protective cover of an electronic device according to an embodiment of the present invention.

FIG. 3A illustrates a protective cover 300 for the first electronic device. Similar to a case of FIG. 2A, a first piece 301 and a second piece 302 of the protective cover 300 are connected, and the first piece 301 or the second piece 302 may be moved so that the protective cover 300 can be folded or unfolded. Further, the first electronic device contacts with and is attached to the right inside surface, and at the left inside surface, an interface that controls a connection and an interaction between the second electronic device and the first electronic device may be provided.

FIG. 3B illustrates a case in which a second electronic device 310, which is in the same size as or a size similar to that of a first electronic device 320, is placed at the left inside surface of the protective cover 300 of FIG. 3A.

For example, when the second electronic device 310 is placed at a partial surface of the left inside surface, a Peer-to-Peer (P2P) communication method that can be used to connect the first electronic device 320, or all of the P2P communication methods (e.g., a Bluetooth communication method, a Wi-Fi Direct communication method) in which the first electronic device 320 or the second electronic device 310 supports, may be displayed on a screen of the second electronic device 310. Although not shown, other communication methods (IEEE 802.15 TG8 Peer Aware Communication (PAC), 3GPP Proximity Service (ProSe), IEEE 802.16 Project Planning Committee (PPC), FlashLinQ of Qualcomm company) that support P2P communication may be further included.

In an embodiment of the present invention, a P2P communication method that can be used to connect the second electronic device 310, or all of the P2P communication methods (e.g., a Bluetooth communication method, a Wi-Fi Direct communication method) in which the first electronic device 320 or the second electronic device 310 supports, may be displayed on a screen of the first electronic device 320.

In FIG. 3B, when a P2P communication method that can be used to perform communication between the first electronic device 320 and the second electronic device 310 is selected, as shown in FIG. 3C, an interface for sharing a file may be displayed in each of screens of the first electronic device 320 and the second electronic device 310. For example, on the screen of the first electronic device 320, an instruction icon for transmitting at least one corresponding file from the first electronic device 320 to the second electronic device 310 and an instruction icon for transmitting (executing or maintaining) a current task screen of the first electronic device 320 to the second electronic device 310 may be displayed. Although not shown, an instruction icon for sharing the screen of the first electronic device 320 with the second electronic device 310 or an instruction icon for displaying a virtual keyboard, as an input device for the second electronic device 310, in the first electronic device 320 may be further displayed.

Similarly, on the screen of the second electronic device 310, an instruction icon for transmitting at least one corresponding file from the second electronic device 310 to the first electronic device 320 and an instruction icon for transmitting a current task screen of the second electronic device 310 to the first electronic device 320 may be displayed. Although not shown, an instruction icon for sharing the screen of the second electronic device 310 with the first electronic device 320 or an instruction icon for displaying a virtual keyboard, as an input device for the first electronic device 320, in the second electronic device 310 may be further displayed.

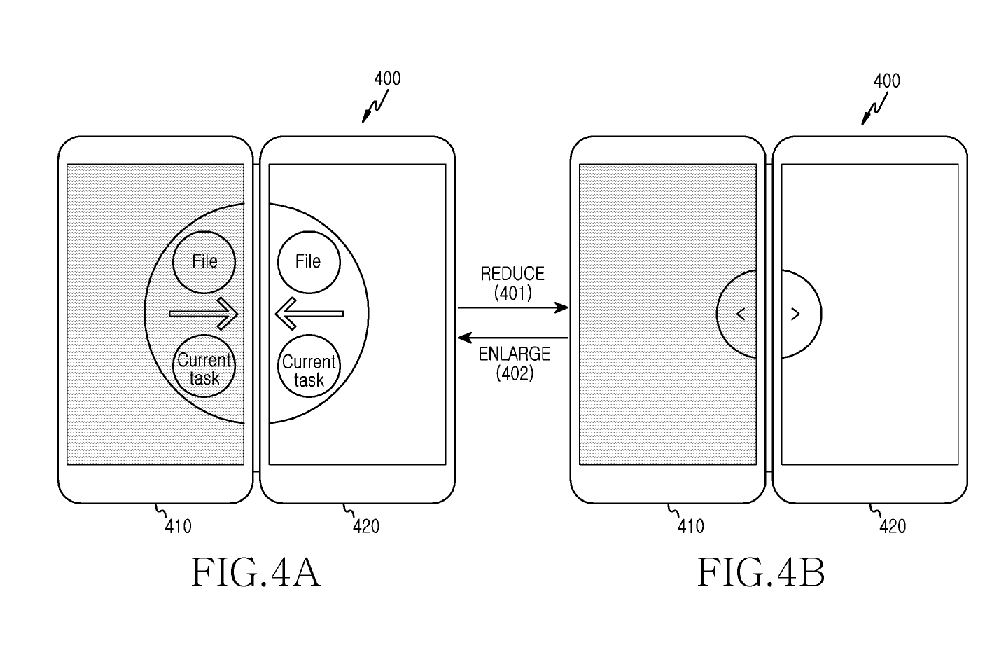

FIGS. 4A-4B illustrate an example of using the inside of a protective cover of an electronic device according to an embodiment of the present invention.

FIG. 4A is shown as in the same situation as that of FIG. 3C. As a P2P communication method between a first electronic device 420 and a second electronic device 410 is selected, on each of screens of the first electronic device 420 and the second electronic device 410, an interface for sharing a file may be displayed.

When a corresponding instruction icon (File or Current task) displayed on screens of the first electronic device 420 and the second electronic device 410 is reduced 401 as shown from FIG. 4A to FIG. 4B, circle-shaped instruction icons disappear as shown in FIG. 4B. In an embodiment of the present invention, only one screen of the first electronic device 420 and the second electronic device 410 may be reduced.

When circle-shaped instruction icons disappear as shown in FIG. 4B, the circle-shaped instruction icons which disappeared may be enlarged 402 as shown from FIG. 4B to FIG. 4A, and may be displayed as shown in FIG. 4A.

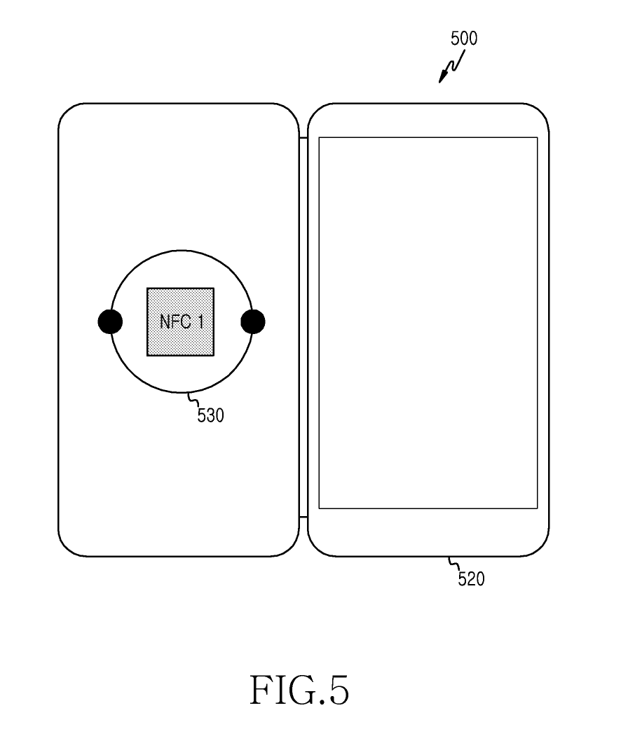

FIG. 5 illustrates a protective cover including a NFC module of an electronic device according to an embodiment of the present invention.

Referring to FIG. 5, a first piece and a second piece of a protective cover 500 are connected, and the first piece or the second piece may be moved so that the protective cover 500 can be folded and unfolded. Further, a first electronic device 520 contacts with and is attached to the right inside surface, and at the left inside surface, an interface that controls a connection and an interaction between a second electronic device and the first electronic device 520 may be provided.

In an embodiment of the present invention, at the left inside surface, an NFC module 530 is provided, and the NFC module 530 includes an action code by which the second electronic device performs a operation. When the second electronic device is placed at the left inside surface, an action code stored at the NFC module 530 may be transferred to the second electronic device. For example, the action code may induce an action that starts a sharing user interface that allows a user to select whether to share a screen of the first electronic device 520 or the second electronic device. Further, while an action code is set to the NFC module 530, a unique identifier (ID) of the first electronic device 520 or connectivity capabilities (e.g., Bluetooth communication method, Wi-Fi direct communication method) information of the first electronic device 520 may be added.

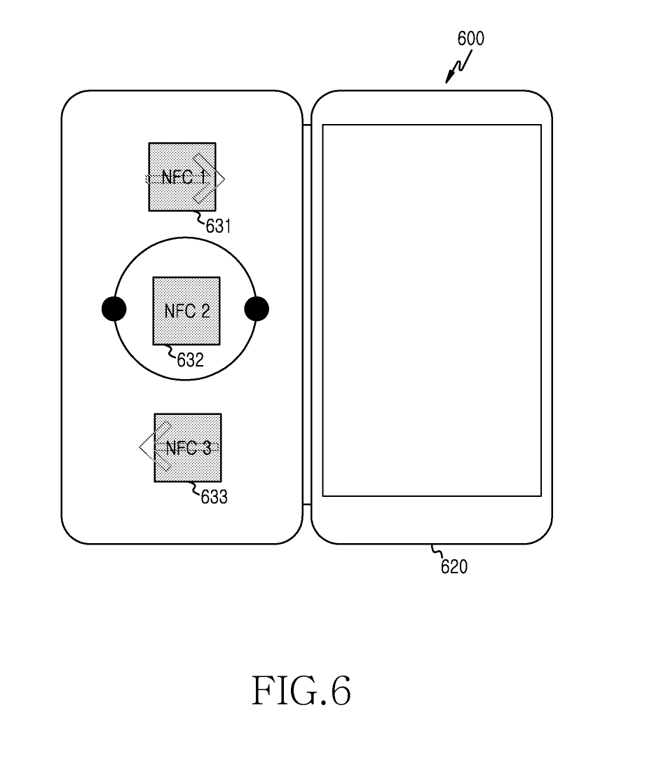

FIG. 6 illustrates a protective cover including an NFC module of an electronic device according to an embodiment of the present invention. As shown in FIG. 6, a plurality of NFC module may be provided at the left inside surface of a protective cover.

Referring to FIG. 6, a first piece and a second piece of a protective cover 600 are connected, and the first piece or the second piece may be moved so that the protective cover 600 can be folded or unfolded. Further, a first electronic device 620 contacts with and is attached to the right inside surface, and at the left inside surface, an interface for controlling a connection and an interaction between a second electronic device and the first electronic device 620 may be provided.

In an embodiment of the present invention, at the left inside surface, three NFC modules 631, 632, and 633 are provided, and the NFC modules 631, 632, and 633 may each include different action codes by which the second electronic device performs a operation. When the second electronic device is placed on an area, in which a corresponding NFC module is provided, of the left inside surface, an action code stored at the corresponding NFC module may be transferred to the second electronic device. For example, the NFC module 631 may store a first action code for sharing data or a screen of the second electronic device with the first electronic device 620, the NFC module 632 may store a second action code for connecting to the first electronic device 620, and the NFC module 633 may store a third action code for requesting to receive contents displayed on a screen of the first electronic device 620. Further, while each action code is set to the NFC modules 631, 632, and 633, a unique ID of the first electronic device 620 or connectivity capabilities (e.g., Bluetooth communication method, Wi-Fi direct communication method) information of the first electronic device 620 may be added.

According to an embodiment of the present invention, another communication method (e.g., Bluetooth Low Energy) may be used instead of using an NFC module. For example, when the first electronic device stores corresponding action codes and the second electronic device is placed at a corresponding location of the protective cover, the first electronic device may recognize the second electronic device and broadcast a Bluetooth Low Energy (BLE) signal including a corresponding action code. The second electronic device placed on the protective cover may receive a BLE signal including a corresponding action code and perform a corresponding operation.

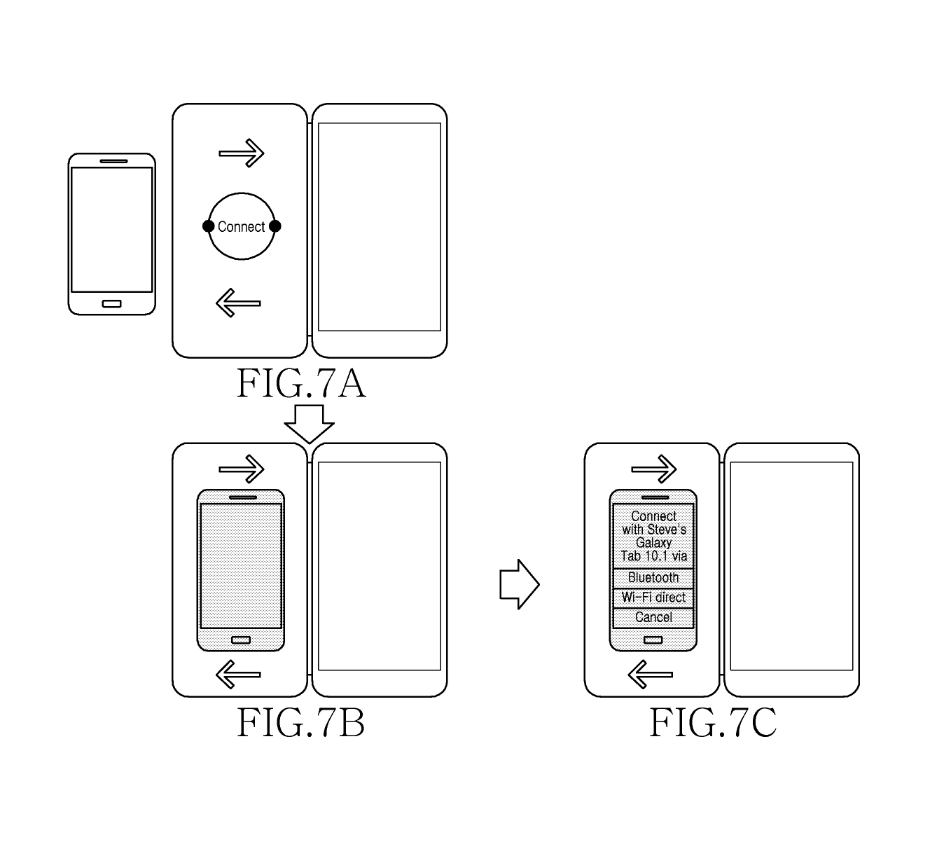

FIGS. 7A-7C illustrate a connection between a first electronic device and a second electronic device through a protective cover including an NFC module according to an embodiment of the present invention.

Referring to FIG. 7A, the first electronic device is attached to the right inside surface of a protective cover, and at the left inside surface, an NFC module that stores each action code is provided, similar as shown in FIG. 6.

FIG. 7B illustrates a state in which a second electronic device is placed on a second NFC module (similar to NFC 2 shown in FIG. 6) at a left inside surface of the protective cover. In this case, a second action code recoded or stored at the second NFC module of the protective cover may be transferred to the second electronic device. The second action code may be an action code for a P2P communication connection according to a method in which the second electronic device communicates with the first electronic device.

Referring to FIG. 7C, the second electronic device displays a communication choice that can be used to connect to the first electronic device according to the second action code. For example, a Bluetooth communication method and a Wi-Fi direct communication method that can be used to connect to the first electronic device may be displayed on a screen of the second electronic device.

According to an embodiment of the present invention, when the second electronic device is placed on a second NFC module at a left inside surface of the protective cover, an unique ID and connectivity capabilities information of the second electronic device is transferred to the first electronic device through the second NFC module, and thus, the first electronic device may display a communication choice that can be used to connect to the second electronic device.

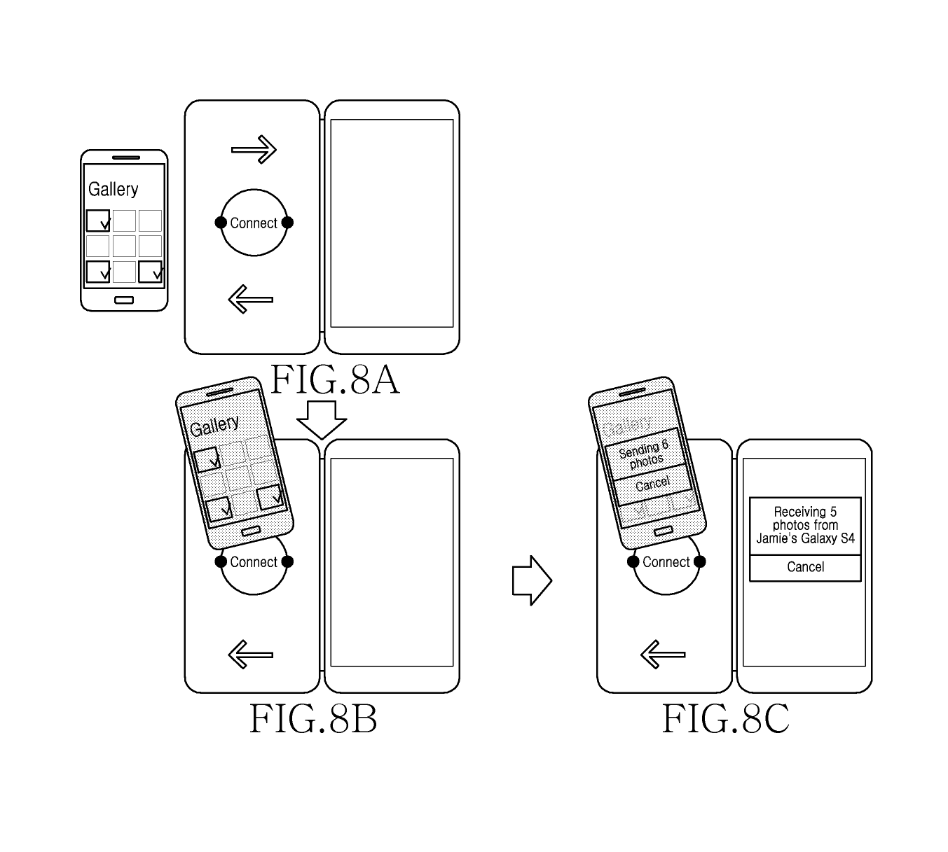

FIGS. 8A-8C illustrate an example of sharing data of a second electronic device through a connection between a first electronic device and the second electronic device using a protective cover including an NFC module according to an embodiment of the present invention.

Referring to FIG. 8A, the first electronic device is attached to right inside surface of the protective cover, and at left inside surface of the protective cover, an NFC module that records each action code is provided, similar as shown in FIG. 6.

FIG. 8B illustrates a state in which the second electronic device is placed on a first NFC module (similar to NFC 1 shown in FIG. 6) at the left inside surface of the protective cover. In this case, a first action code recoded at a first NFC module of the protective cover may be transferred to the second electronic device. The first action code may be an action code that shares data of the second electronic device. According to an embodiment of the present invention, data (e.g., pictures of a gallery) of the second electronic device, which the second electronic device shares, may be selected.

Referring to FIG. 8C, data (e.g., pictures selected from a gallery) of the second electronic device to be shared is transmitted to the first electronic device according to the first action code.

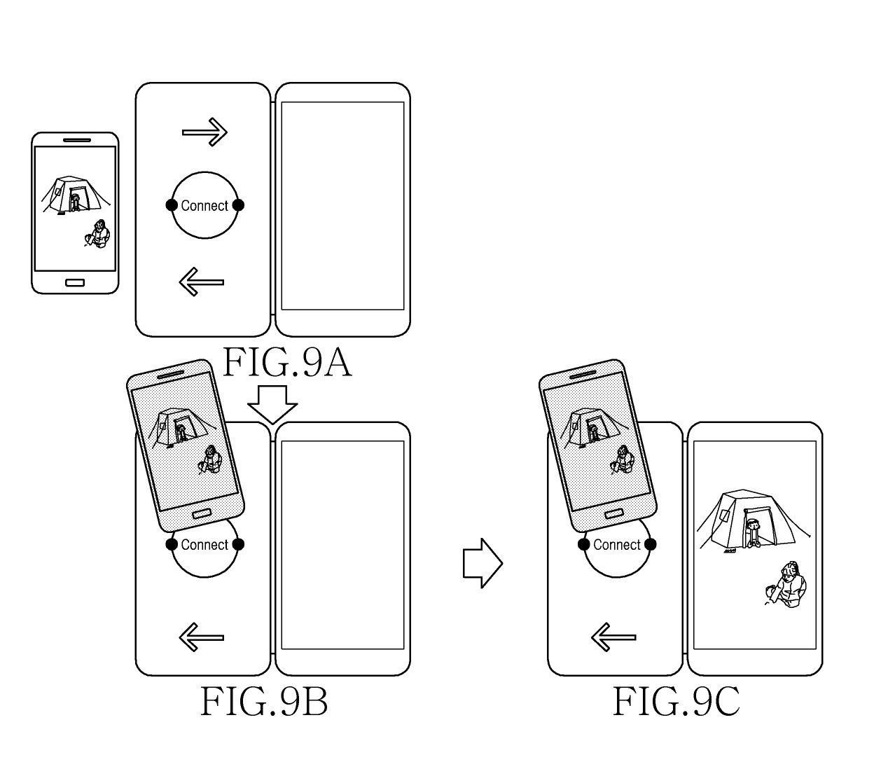

FIGS. 9A-9C illustrate an example of sharing a screen of a second electronic device through a connection between a first electronic device and the second electronic device using a protective cover including an NFC module according to an embodiment of the present invention.

Referring to FIG. 9A, the first electronic device is attached to the right inside surface of the protective cover, and at the left inside surface of the protective cover, an NFC module that records each action code may be provided, similar as shown in FIG. 6.

FIG. 9B illustrates a state in which the second electronic device is placed on a first NFC module (similar to NFC 1 shown in FIG. 6) at the left inside surface of the protective cover. In this case, a first action code recoded at the first NFC module of the protective cover may be transferred to the second electronic device. The first action code may be an action code that shares a screen of the second electronic device.

Referring to FIG. 9C, as a screen of the second electronic device to be shared is synchronized with the first electronic device according to the first action code, the screen of the second electronic device is displayed on a screen of the first electronic device.

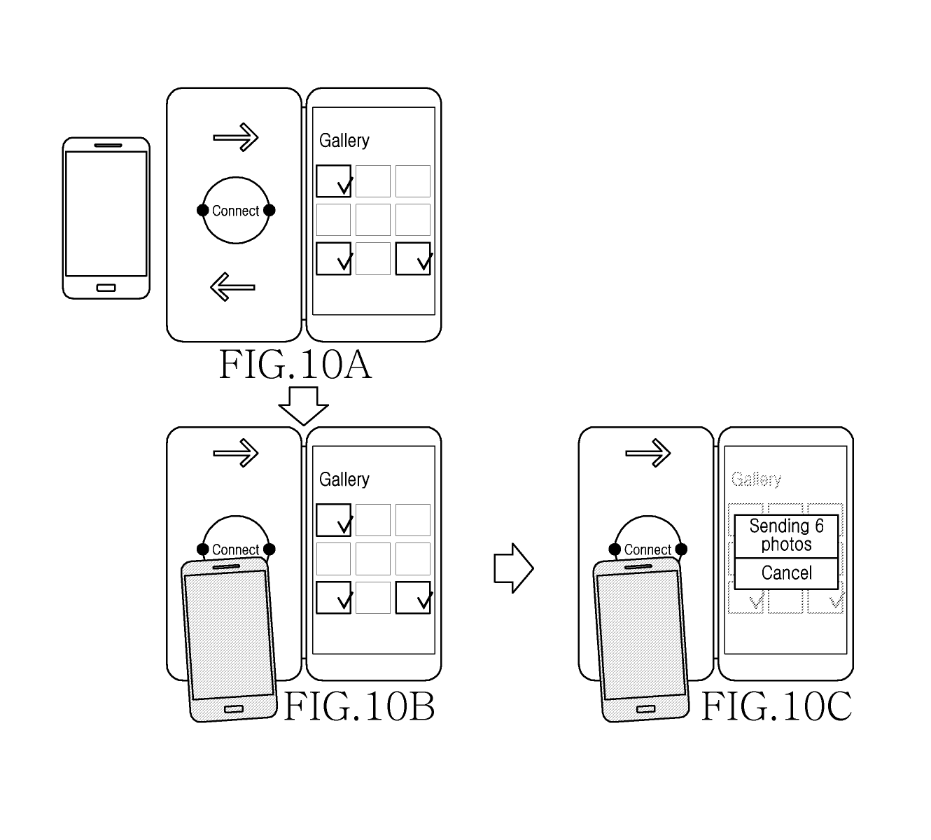

FIGS. 10A-10C illustrate an example of sharing data of a first electronic device through a connection between the first electronic device and a second electronic device using a protective cover including an NFC module according to an embodiment of the present invention.

Referring to FIG. 10A, the first electronic device is attached to the right inside surface of the protective cover, and at the left inside surface of the protective cover, an NFC module that stores each action code may be provided, similar as shown in FIG. 6.

FIG. 10B illustrates a state in which the second electronic device is placed on a third NFC module (similar to NFC 3 shown in FIG. 6) at the left inside surface of a protective cover. In this case, a third action code recoded at the third NFC module of the protective cover may be transferred to the second electronic device. The third action code may be an action code that shares data of the first electronic device. According to an embodiment of the present invention, data (e.g., pictures of a gallery) of the first electronic device, which the first electronic device shares, may be selected.

Referring to FIG. 10C, data (e.g., pictures selected from a gallery) of the first electronic device to be shared is transmitted to the second electronic device according to the third action code.

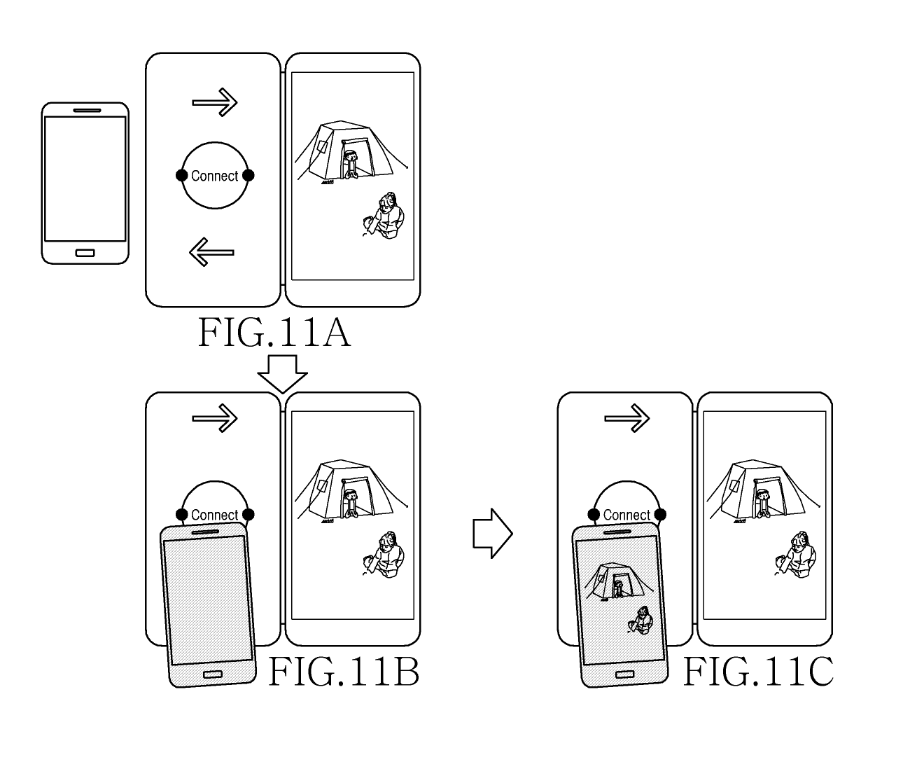

FIGS. 11A-11C illustrates an example of sharing a screen of a first electronic device through a connection between the first electronic device and a second electronic device using a protective cover including an NFC module according to an embodiment of the present invention.

Referring to FIG. 11A, the first electronic device is attached to the right inside surface of the protective cover, and at the left inside surface of the protective cover, an NFC module that records each action code may be provided, similar as shown in FIG. 6.

FIG. 11B illustrates a state in which the second electronic device is placed on a third NFC module (similar to NFC 3 shown in FIG. 6) at the left inside surface of the protective cover. In this case, a third action code recoded at the third NFC module of the protective cover may be transferred to the second electronic device. The third action code may be an action code that shares a screen of the first electronic device.

Referring to FIG. 11C, as a screen of the first electronic device to be shared is synchronized with the second electronic device according to the third action code, the screen of the first electronic device is displayed on a screen of the second electronic device.

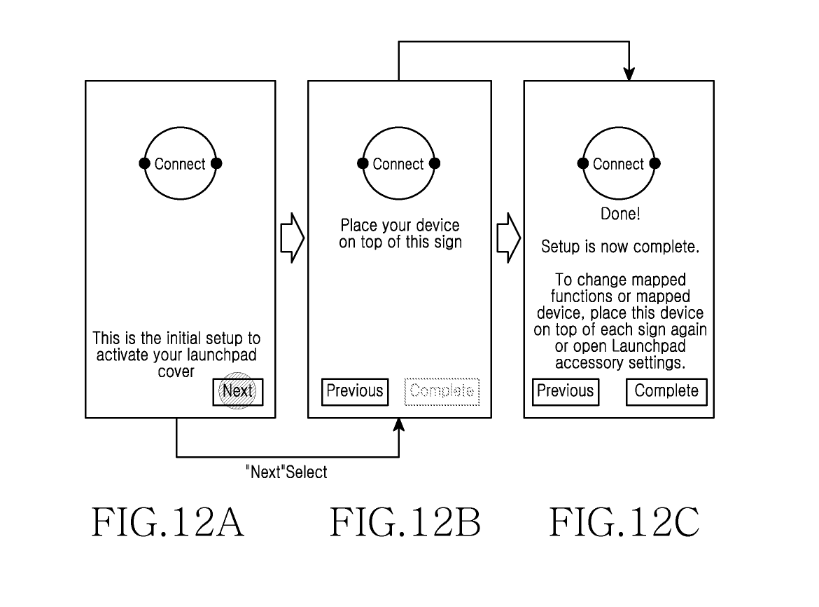

FIGS. 12A-12C illustrate screens for initial setup between a first electronic device and a protective cover including an NFC module according to an embodiment of the present invention.

In FIG. 12A, when a menu for initial setup between the protective cover and the first electronic device is selected, in the first electronic device, a screen notifying initial setup between the protective cover and the first electronic device is displayed. When “Next” is selected, in the first electronic device, a screen notifying a user to place the first electronic device on the protective cover is displayed as shown in FIG. 12B.

In an embodiment of the present invention, when the first electronic device is placed on the protective cover by the user, ID information of an NFC module of the protective cover may be provided to the first electronic device and be stored within the first electronic device, and the first electronic device may recode unique ID information (e.g., Bluetooth MAC address, or Wi-Fi direct MAC address) thereof in the NFC module of the protective cover. When such a process is complete, as shown in FIG. 12C, the first electronic device displays a message notifying a user that initial setup between the protective cover and the first electronic device is complete on a screen thereof.

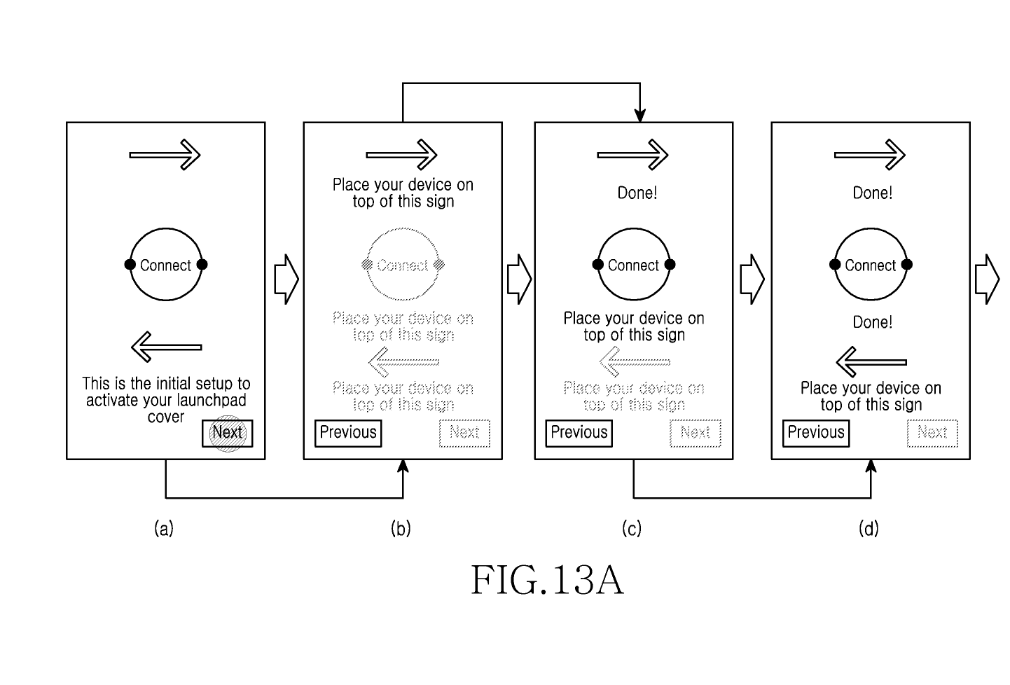

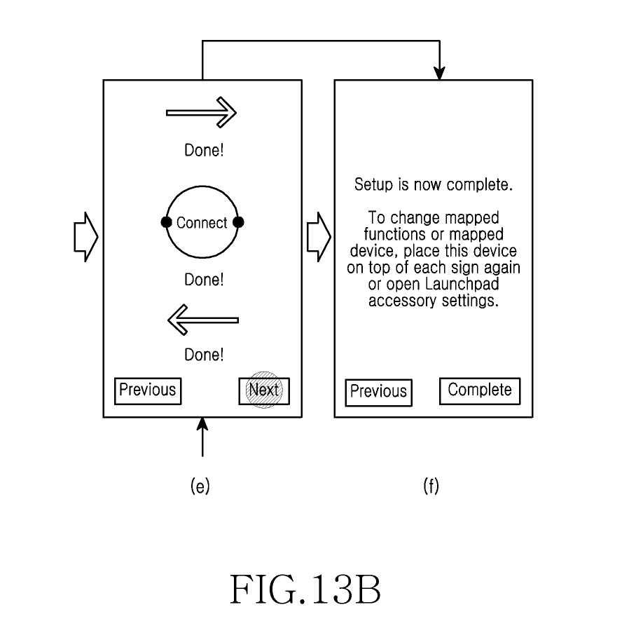

FIGS. 13A and 13B illustrate a process that sets an NFC module of the protective cover according to an embodiment of the present invention.

Referring to FIG. 13A(a), when a menu of setting an NFC module of the protective cover is selected, in a first electronic device, a screen that sets an NFC module of the protective cover is displayed.

When “Next” is selected, in the first electronic device, a screen that requests to a user to place the first electronic device on the respective NFC module is displayed as shown in FIG. 13A(b). Here, in FIG. 13A(b), the top message “place your device on top of this sign” refers to “place the first electronic device on the first NFC module”, the middle message “place your device on top of this sign” refers to “place the first electronic device on the second NFC module”, and the bottom message “place your device on top of this sign” refers to “place the first electronic device on the third NFC module”.

In order to set a first NFC module of the protective cover, a user places the first electronic device on the first NFC module. In an embodiment of the present invention, when the NFC module of the first electronic device and the first NFC module of the protective cover contact, unique ID information of the first electronic device (MAC address of a corresponding communication method), connectivity capabilities information (e.g., Wi-Fi direct communication method, Bluetooth communication method), or a first action code for the first NFC module of the protective cover is recoded in the first NFC module of the protective cover When recoding is terminated, a message (the top message of FIG. 13A(c)) notifying a user that setup between the first electronic device and the first NFC module is completed is displayed as shown in FIG. 13A(c).

In order to set a second NFC module of the protective cover, a user places the first electronic device on a second NFC module. In an embodiment of the present invention, when the NFC module of the first electronic device and the second NFC module of the protective cover contact, unique ID information of the first electronic device (MAC address of a corresponding communication method), connectivity capabilities information (e.g., Wi-Fi direct communication method, Bluetooth communication method), or a second action code for the second NFC module of the protective cover is recoded in the second NFC module of the protective cover When recording is terminated, a message (the middle message of FIG. 13A(d)) notifying a user that setup between the first electronic device and the second NFC module is completed is displayed as shown in FIG. 13A(d).

In order to set a third NFC module of the protective cover, a user places the first electronic device on the third NFC module. In an embodiment of the present invention, when the NFC module of the first electronic device and the third NFC module of the protective cover contact, unique identification information of the first electronic device (MAC address of a corresponding communication method), connectivity capabilities information (e.g., Wi-Fi direct communication method, Bluetooth communication method), or a third action code for the third NFC module of the protective cover is recoded in the third NFC module of the protective cover. When recording is terminated, a message (the bottom message of FIG. 13B(e)) notifying a user that setup between the first electronic device and the third NFC module is completed is displayed as shown in FIG. 13B(e). When “Next” is selected, the first electronic device displays a message notifying a user that initial setup for all of the NFC modules of the protective cover is complete, as shown in FIG. 13B(f).

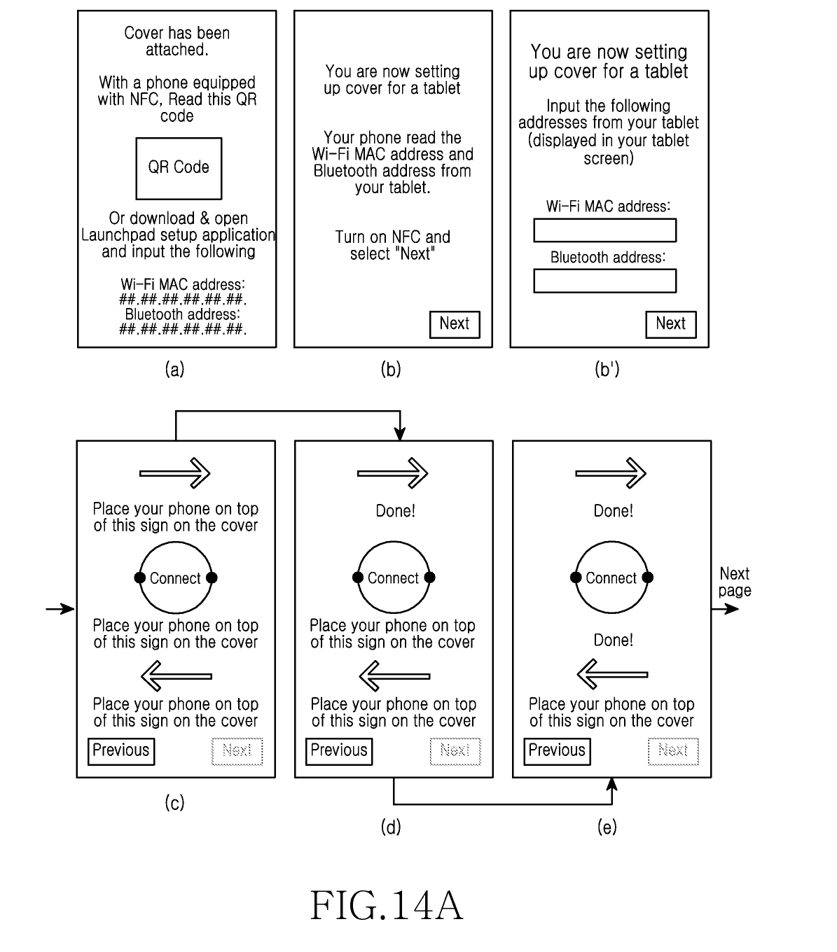

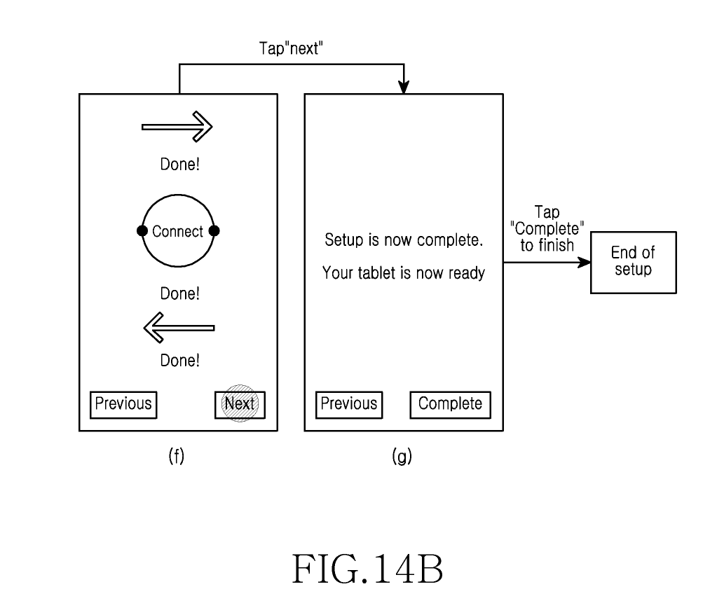

In FIGS. 13A-13B, when the first electronic device includes an NFC module, an example for initial setup is described However, when the first electronic device does not include an NFC module, the first electronic device may perform initial setup using a second electronic device that can scan a Quick Response (QR) code, which is illustrated with FIG. 14.

FIGS. 14A and 14B illustrate a process that sets an NFC module of a protective cover according to an embodiment of the present invention. Here, the first electronic device does not include an NFC module, while the second electronic device includes an NFC module and can read a QR code.

In FIG. 14A(a), when the first electronic device is initially attached to a protective cover, a QR code is displayed on a screen of the first electronic device including information about the first electronic device, and a Wi-Fi direct MAC address and a Bluetooth MAC address may be encoded and displayed. In an embodiment of the present invention, another bar code may be used instead of a QR code.

The second electronic device scans a QR code of the first electronic device and notifies the first electronic device that unique identification information (e.g., Wi-Fi direct MAC address and Bluetooth MAC address) of the first electronic device has been acquired.

In an embodiment of the present invention, the second electronic device may downward an App for setting a protective cover of the first electronic device and request and acquire unique identification information of the first electronic device.

As shown in FIG. 14A(b) or FIG. 14A(b′), when the second electronic device acquires unique identification information of the first electronic device through reading the QR code or inputting the information, a message notifying a user that reading is completed and a request for turning on the NFC module of the second electronic device are displayed on the screen of the first electronic device, as shown in FIG. 14A(b), or a request for inputting the information is displayed on the screen of the first electronic device, as shown in FIG. 14A(b′). Here, after inputting the information, the NFC module of the second electronic device may be automatically turned on, or another request for turning on the NFC module of the second electronic device may be displayed.

Once the unique ID information of the first electronic device is acquired by the second electronic device and the NFC module of the second electronic device is turned on, in the first electronic device, a screen that requests to a user to place the first electronic device on the respective NFC module is displayed as shown in FIG. 14A(c). Here, in FIG. 14A(c), the top message “place your device on top of this sign” refers to “place the second electronic device on the first NFC module of a protective cover”, the middle message “place your device on top of this sign” refers to “place the second electronic device on the second NFC module of a protective cover”, and the bottom message “place your device on top of this sign” refers to “place the second electronic device on the third NFC module of a protective cover”.

In order to set a first NFC module of the protective cover to the first electronic device, a user places the second electronic device on the first NFC module. In an embodiment of the present invention, when the NFC module of the second electronic device and the first NFC module of the protective cover contact, unique identification information of the first electronic device (MAC address of a corresponding communication method), connectivity capabilities information (e.g., Wi-Fi direct communication method, Bluetooth communication method), or a first action code for the first NFC module of the protective cover is recoded in the first NFC module of the protective cover, and when recording is terminated, a message (the top message of FIG. 14A(d)) notifying a user that setup between the first electronic device and the first NFC module is completed is displayed as shown in FIG. 14A(d).

In order to set a second NFC module of the protective cover a user places the second electronic device on the second NFC module. In an embodiment of the present invention, when the NFC module of the second electronic device and the second NFC module of the protective cover contact, unique identification information of the first electronic device (MAC address of a corresponding communication method), connectivity capabilities information (e.g., Wi-Fi direct communication method, Bluetooth communication method), or a second action code for the second NFC module of the protective cover is recoded in the second NFC module of the protective cover. When recording is terminated, a message (the middle message of FIG. 14A (e)) notifying a user that setup between the first electronic device and the second NFC module is completed is displayed as shown in FIG. 14A(e).

In order to set a third NFC module of the protective cover, a user places the second electronic device on the third NFC module. In an embodiment of the present invention, when the NFC module of the second electronic device and the third NFC module of the protective cover contact, unique identification information of the first electronic device (MAC address of a corresponding communication method), connectivity capabilities information (e.g., Wi-Fi direct communication method, Bluetooth communication method), or a third action code for the third NFC module of the protective cover is recoded in the third NFC module of the protective cover. When recording is terminated, a message (the bottom message of FIG. 14B (f)) notifying a user that setup between the first electronic device and the third NFC module is completed is displayed as shown in FIG. 14B(f). When “Next” is selected, the second electronic device displays a message notifying a user that initial setup for all of the NFC modules of the protective cover is complete, as shown in FIG. 14B(g).

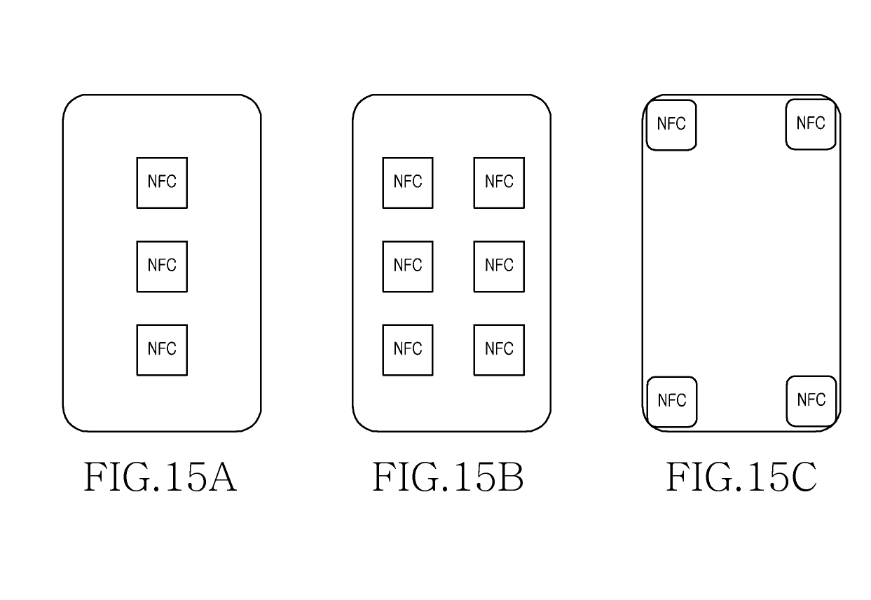

FIGS. 15A-15C illustrate a protective cover including a plurality of NFC modules according to an embodiment of the present invention of the present invention.

FIG. 15A illustrates a protective cover including three NFC modules. FIG. 15B illustrates a protective cover including six NFC modules. FIG. 15C illustrates a protective cover including four NFC modules. In an embodiment of the present invention, the number and a location of NFC modules may be variously changed.

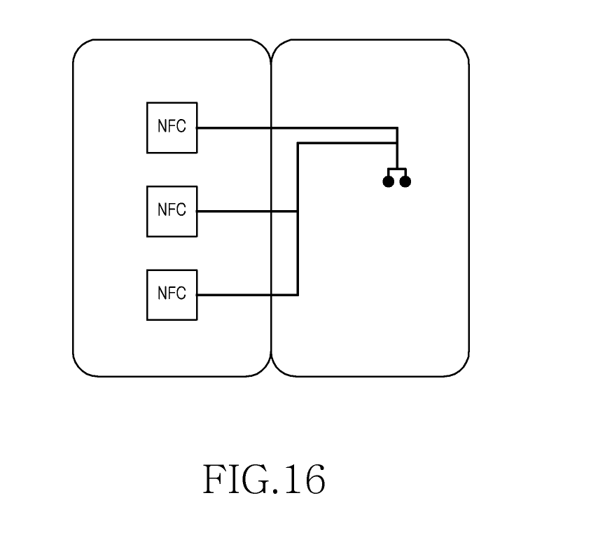

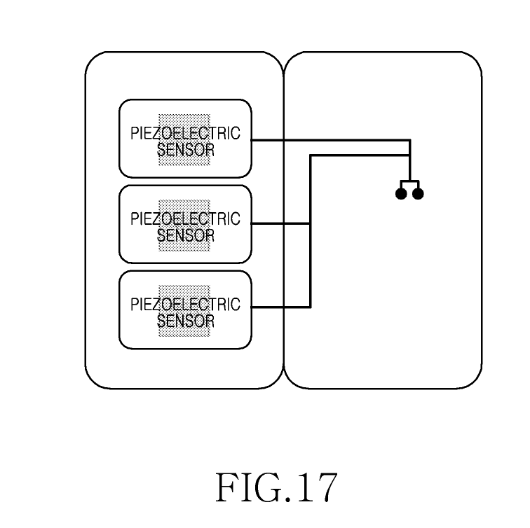

In an embodiment of the present invention, when an NFC reader of the second electronic device is placed in an NFC tag included in the protective cover or approaches an NFC tag included in the protective cover, the second electronic device may receive information (e.g., unique ID or connectivity capabilities information of the first electronic device) about the first electronic device from a corresponding NFC tag included in the protective cover through an NFC reader and may attempt a P2P communication connection (e.g., Bluetooth, Wi-Fi direct) to the first electronic device or may attempt sharing. Meanwhile, when the first electronic device recognizes that the second electronic device has tagged with a corresponding NFC module within a protective cover thereof, the first electronic device may know that the second electronic device attempts a P2P communication connection to the first electronic device or attempts sharing. For example, when the first electronic device recognizes that the second electronic device has tagged with a corresponding NFC module within a protective cover thereof, the first electronic device may convert to a wake up state and prepare to perform a corresponding operation with the second electronic device. FIGS. 16 and 17 illustrate technology in which the first electronic device recognizes that the second electronic device has tagged with a corresponding NFC module within a protective cover of the first electronic device.

In an embodiment of the present invention, when an NFC tag of the second electronic device is placed in an NFC reader of the protective cover of the first electronic device or when an NFC tag of the second electronic device approaches an NFC reader of the protective cover of the first electronic device, the first electronic device may receive information about the second electronic device (e.g., unique identifier or connectivity capabilities information of the second electronic device) from the NFC tag of the second electronic device through the NFC reader and may attempt a P2P communication connection (e.g., Bluetooth, Wi-Fi direct) to the second electronic device or may attempt sharing. Meanwhile, when the second electronic device recognizes that the first electronic device has tagged with a corresponding NFC module within a protective cover of the second electronic device, the second electronic device may know that the first electronic device will attempt a P2P communication connection to the second electronic device or attempt sharing. For example, when the second electronic device recognizes that the first electronic device has tagged with a corresponding NFC module within a protective cover thereof, the second electronic device may convert to a wake up state and prepare to perform a corresponding operation with the first electronic device. This situation is similar to that of FIGS. 16 and 17, and thus, will be omitted from the detailed description.

FIG. 16 illustrates a method of waking up a first electronic device according to an embodiment of the present invention.

Referring to FIG. 16, a plurality of NFC tag modules included in the protective cover of the first electronic device have respective unique IDs and have a connector connected to the first electronic device. Further, a unique ID of each of a plurality of NFC tag modules is stored at the first electronic device and may be used for preventing illegal use, when the protective cover is lost. For example, when an electronic device is attached to the protective cover, which is lost from the first electronic device, it may be determined whether an unique ID of each of a plurality of NFC tag modules stored at the electronic device corresponds with a unique identifier of a plurality of NFC tag modules of the protective cover and it may be determined whether to intercept a connection between the electronic device and the protective cover.

In an embodiment of the present invention, each NFC tag module may be a manual NFC module that does not use power.

In an embodiment of the present invention, when the second electronic device is placed at a corresponding NFC tag of the protective cover or when the second electronic device approaches a corresponding NFC tag of the protective cover, a small amount of power may be supplied from an NFC reader of the second electronic device to a corresponding NFC tag of the protective cover. A small amount of information may be transferred to the NFC reader of the second electronic device through the NFC tag.

In an embodiment of the present invention, when a small amount of power is transferred to an NFC tag of the first electronic device, the small amount of power may be used for transmitting a signal to the first electronic device through a connector of the NFC tag.

In an embodiment of the present invention, when the first electronic device receives a signal from a corresponding NFC tag of the protective cover, the first electronic device may automatically determine and activate a connection option (Bluetooth, Wi-Fi direct), and thus, the second electronic device may attempt a connection to the first electronic device.

In an embodiment of the present invention, when corresponding P2P communication is setup between the second electronic device and the first electronic device, the first electronic device may inactivate other connection options that are not being used.

FIG. 17 illustrates a method of waking up a first electronic device according to an embodiment of the present invention of the present invention.

Referring to FIG. 17, a pressure sensor exists on or under a NFC module of the protective cover. The pressure sensor detects a pressure applied when the second electronic device is placed on a corresponding NFC module and provides a result thereof to the first electronic device through a connector.

When the first electronic device is attached to the protective cover, power of the first electronic device may be supplied to each pressure sensor.

In an embodiment of the present invention, when a received value of the pressure from the pressure sensor is larger or smaller than a threshold, the first electronic device may automatically determine and activate a connection option (Bluetooth, Wi-Fi direct), and the second electronic device may attempt a connection to the first electronic device.

In an embodiment of the present invention, when corresponding P2P communication is setup between the second electronic device and the first electronic device, the first electronic device may inactivate other connection options that are not being used.

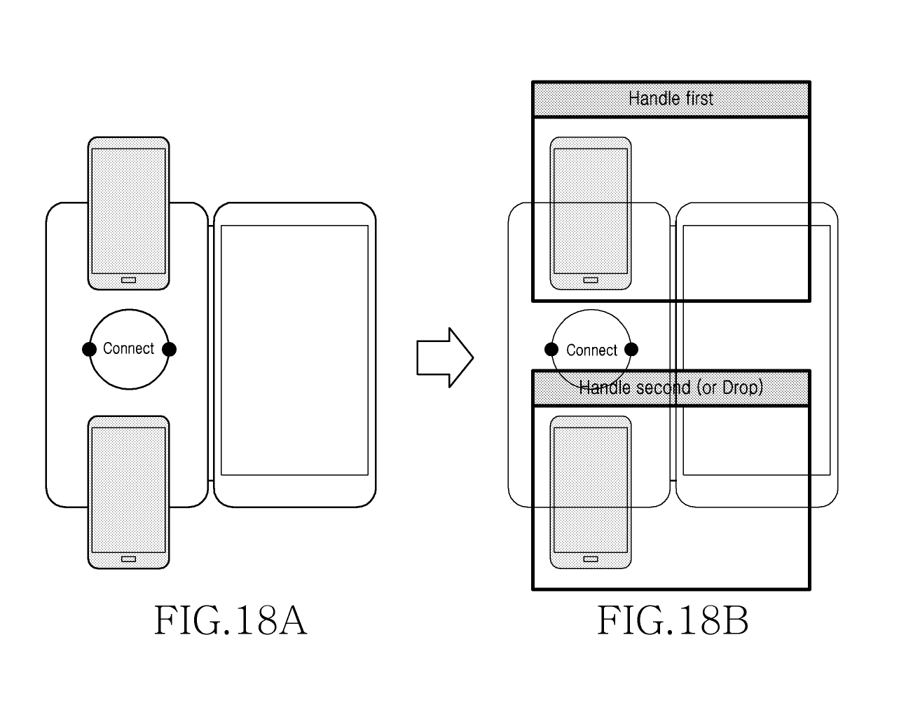

FIGS. 18A-18B illustrate a processing example when at least two different second electronic devices are placed on a protective cover according to an embodiment of the present invention.

When at least two second electronic devices are placed on a protective cover of the first electronic device, for example, as shown in FIG. 18A, when second electronic devices are placed on each of a first NFC module and a third NFC module, action codes recoded in the first NFC module or the third the NFC module are transferred to a corresponding second electronic device according to a priority or randomly, and operations corresponding to the action code may be performed. For example, as shown in FIG. 18B, a P2P communication connection between the first electronic device and the corresponding second electronic device may be attempted, or screen sharing between the first electronic device and the corresponding second electronic device may be attempted.

According to an embodiment of the present invention, action codes recoded in each of the first NFC module and the third NFC module may be simultaneously or sequentially executed.

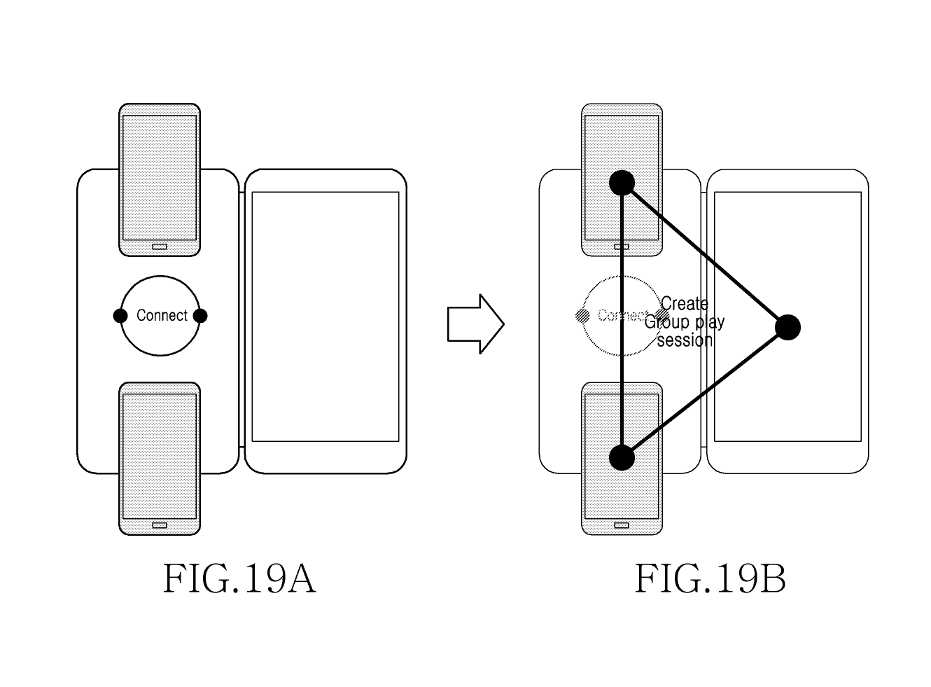

FIGS. 19A-19B illustrate a processing example when at least two different second electronic devices are placed on a protective cover according to an embodiment of the present invention of the present invention.

When at least two second electronic devices are placed on a protective cover, for example, as shown in FIG. 19A, when second electronic devices are placed in each of a first NFC module and a third NFC module, a group communication connection between the first electronic device and the second electronic devices may be performed, as shown in FIG. 19B.

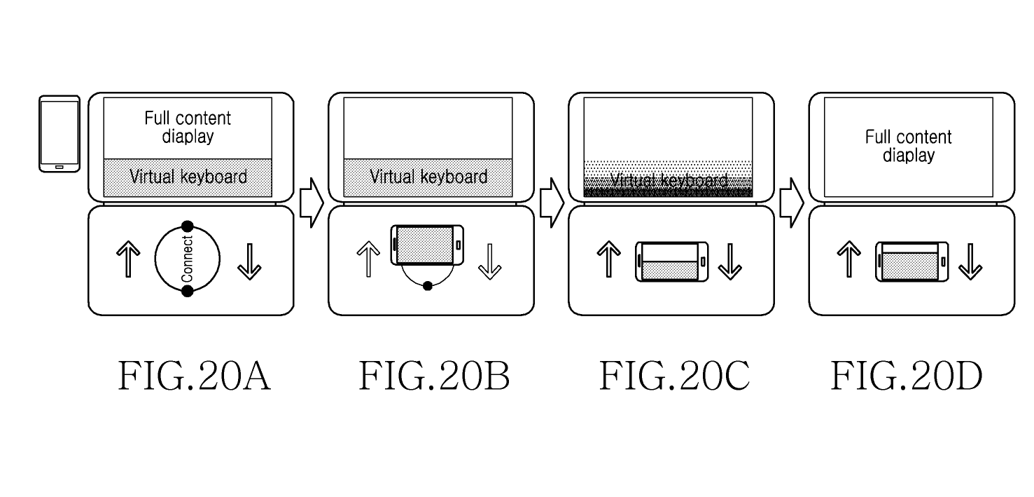

FIGS. 20A-20D illustrate an interaction between a first electronic device and a second electronic device through a connection between the first electronic device and the second electronic device using a protective cover according to an embodiment of the present invention of the present invention.

Referring to FIG. 20A, before the second electronic device is placed on the protective cover, a virtual keyboard is displayed on a screen of the first electronic device.

Referring to FIG. 20B, when the second electronic device is placed on the protective cover, as shown in FIG. 20C, a screen of the first electronic device is synchronized with a screen of the second electronic device, and the screen of the first electronic device is displayed on the screen of the second electronic device.

Referring to FIG. 20D, while the screen of the first electronic device and the screen of the second electronic device are synchronized, when a control signal is transmitted from the first electronic device to the second electronic device, a virtual keyboard on the screen of the first electronic device disappears, and a virtual keyboard may be displayed only on the screen of the second electronic device.

In an embodiment of the present invention, a virtual keyboard on the screen of the second electronic device may be used as an input device of the first electronic device.

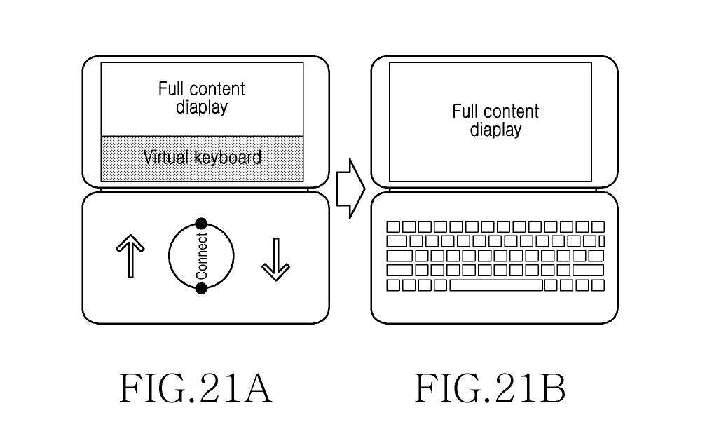

FIGS. 21A-21B illustrate an interaction between a first electronic device and a second electronic device through a connection between the first electronic device and the second electronic device using a protective cover according to an embodiment of the present invention of the present invention.

Referring to FIG. 21A, before the second electronic device is placed on the protective cover, a virtual keyboard is displayed on a screen of the first electronic device. The second electronic device may be a wireless keyboard that supports NFC and Bluetooth communication methods.

Referring to FIG. 21B, when the second electronic device is placed on the protective cover of the first electronic device, a virtual keyboard on the screen of the first electronic device disappears, and a wireless keyboard of the second electronic device is set as an input device of the first electronic device.

In FIGS. 2A to 21B, symbols (e.g., arrow, connection symbols) displayed on a cover may be changed to various shapes and forms, or may be omitted.

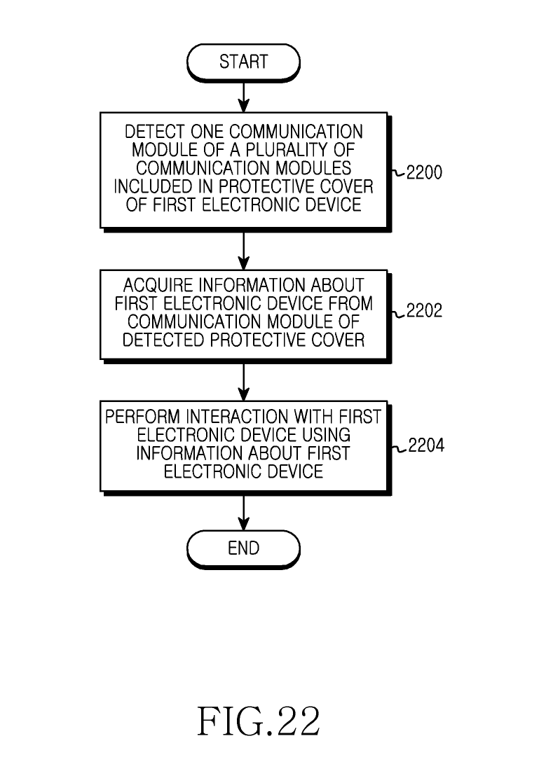

FIG. 22 is a flowchart illustrating an operation of a second electronic device according to an embodiment of the present invention.

Referring to FIG. 22, the second electronic device detects one communication module of a plurality of communication modules (e.g., NFC module) included in a protective cover in step 2200. For example, as shown in FIG. 5 or 6, a second NFC module (i.e., NFC reader) of the second electronic device may determine whether the second electronic device contacts with one of a plurality of NFC modules (i.e., NFC tags) included in the protective cover. However, in an embodiment of the present invention, the communication module is not limited to an NFC module and a Bluetooth communication method, and a Wi-Fi direct communication method for short range communication may be used.

The second electronic device acquires (or receives) information about the first electronic device from the detected communication module of the protective cover in step 2202. The information about the first electronic device may include unique identification information, information about connectivity capabilities, or an action code corresponding to a corresponding operation (e.g., screen sharing, P2P communication connection) of the first electronic device.

For example, as shown in FIGS. 12A-12C and 13A-13B, the information about the first electronic device is recoded in each communication module of the protective cover.

The second electronic device performs an interaction with the first electronic device using the information about the first electronic device that is received from a corresponding communication module of the protective cover of the first electronic device in step 2204. For example, as shown in FIGS. 7A-7C, the second electronic device attempts a P2P connection to the first electronic device using the information about connectivity capabilities of the first electronic device; as shown in FIGS. 8A-8C and 9A-9C, in order to share data, the second electronic device transmits data to be shared to the first electronic device; as shown in FIGS. 10A-10C and 11A-11C, in order to share data, the second electronic device requests and receives sharing data from the first electronic device.

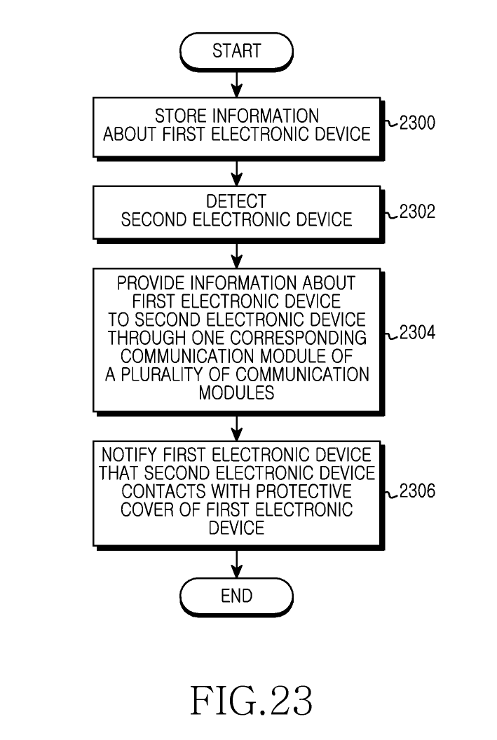

FIG. 23 is a flowchart illustrating an operation of a protective cover according to an embodiment of the present invention.

Referring to FIG. 23, the protective cover (or a third electronic device) stores information about the first electronic device in step 2300. For example, as shown in FIGS. 12A-12C and 13A-13B, the information about the first electronic device is recoded and stored at each of communication modules of the protective cover.

The protective cover detects the second electronic device in step 2302. For example, the protective cover recognizes whether a corresponding NFC module (NFC tag) of the protective cover contacts with an NFC module (NFC reader) of the second electronic device.

The protective cover provides information about the first electronic device to the second electronic device through one corresponding communication module of a plurality of communication modules in step 2304. The information about the first electronic device may include unique identification information, information about connectivity capabilities, or an action code corresponding to a corresponding operation (e.g., screen sharing, P2P communication connection) of the first electronic device.

The protective cover notifies the first electronic device that the second electronic device contacts with the protective cover in step 2306. Therefore, the first electronic device may recognize an interaction with the second electronic device, which contacts with the protective cover, and prepare the interaction with the second electronic device.

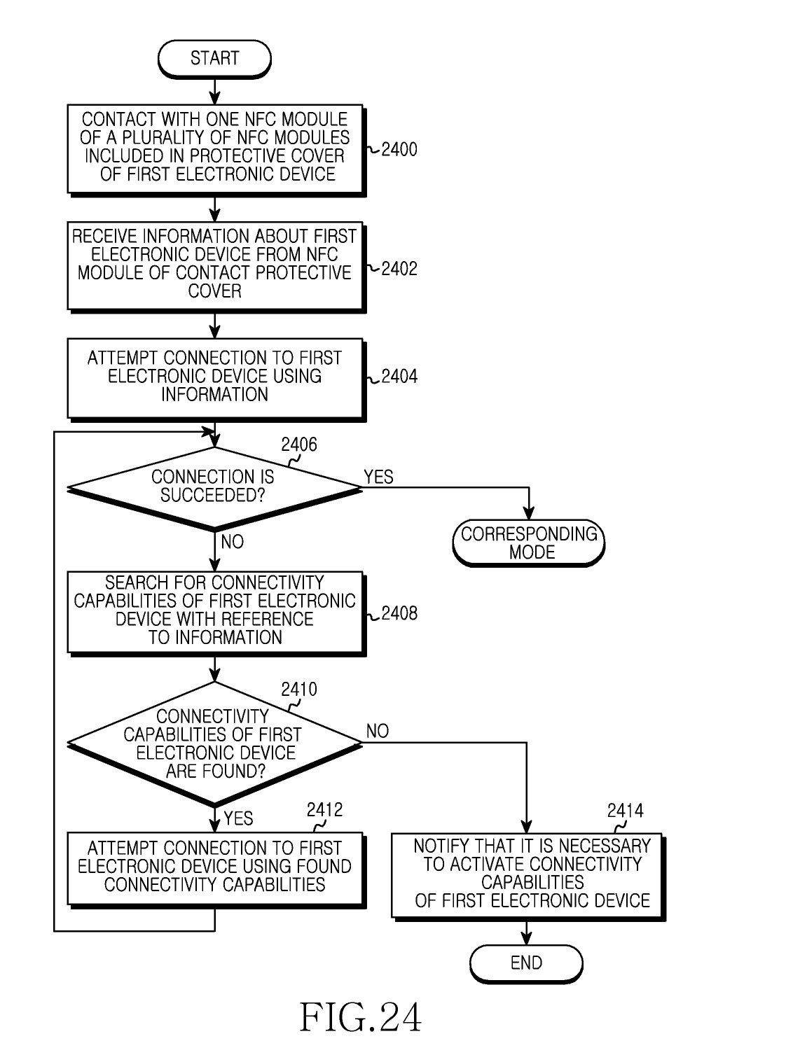

FIG. 24 is a flowchart illustrating an operation of a second electronic device according to an embodiment of the present invention.

Referring to FIG. 24, the second electronic device contacts with one NFC module of a plurality of NFC modules included in a protective cover in step 2400. For example, as shown in FIG. 5 or 6, a second NFC module (i.e., NFC reader) of the second electronic device contacts with one of a plurality of NFC modules (i.e., NFC tag) included in the protective cover. However, the communication module is not limited to an NFC module, and a Bluetooth direct communication method or a Wi-Fi direct communication method for short range communication may be used.

The second electronic device receives information about the first electronic device from the NFC module of the protective cover in step 2402. The information about the first electronic device may include unique identification information, information about connectivity capabilities, or an action code corresponding to a corresponding operation (e.g., screen sharing, P2P communication connection) of the first electronic device. For example, as shown in FIGS. 12A-12C and 13A-13B, the information about the first electronic device is recoded in each of NFC modules of the protective cover.

The second electronic device attempts a P2P communication connection to the first electronic device using information about connectivity capabilities or unique identification information of the first electronic device in step 2404. For example, as shown in FIG. 7C, communication methods that can be used to connect to the first electronic device are displayed on a screen of the second electronic device, a communication method is selected by a user, and a P2P communication connection is attempted using the selected communication method.

The second electronic device determines whether a P2P connection to the first electronic device is succeeded in step 2406, and if a P2P connection to the first electronic device is succeeded, the second electronic device enters a corresponding mode.

If a P2P connection to the first electronic device is failed, the second electronic device searches for connectivity capabilities of the first electronic device with reference to the information about the first electronic device in step 2408.

The second electronic device determines whether connectivity capabilities of the first electronic device are found in step 2410, and if connectivity capabilities of the first electronic device are found, the second electronic device attempts a P2P connection to the first electronic device using the found connectivity capabilities in step 2412.

If connectivity capabilities of the first electronic device are not found, the second electronic device notifies a user through a message window or a pop-up window that it is necessary to activate connectivity capabilities of the first electronic device in step 2414.

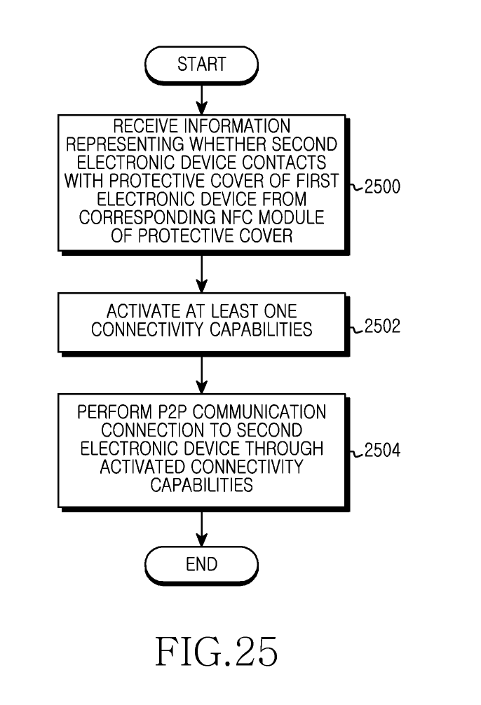

FIG. 25 is a flowchart illustrating an operation of a first electronic device according to an embodiment of the present invention.

Referring to FIG. 25, the first electronic device receives information representing whether a second electronic device contacts with a protective cover from a corresponding NFC module of the protective cover in step 2500.

The first electronic device activates at least one of connectivity capabilities in step 2502, and attempts or performs a P2P communication connection to the second electronic device through the activated at least one of connectivity capabilities in step 2504.

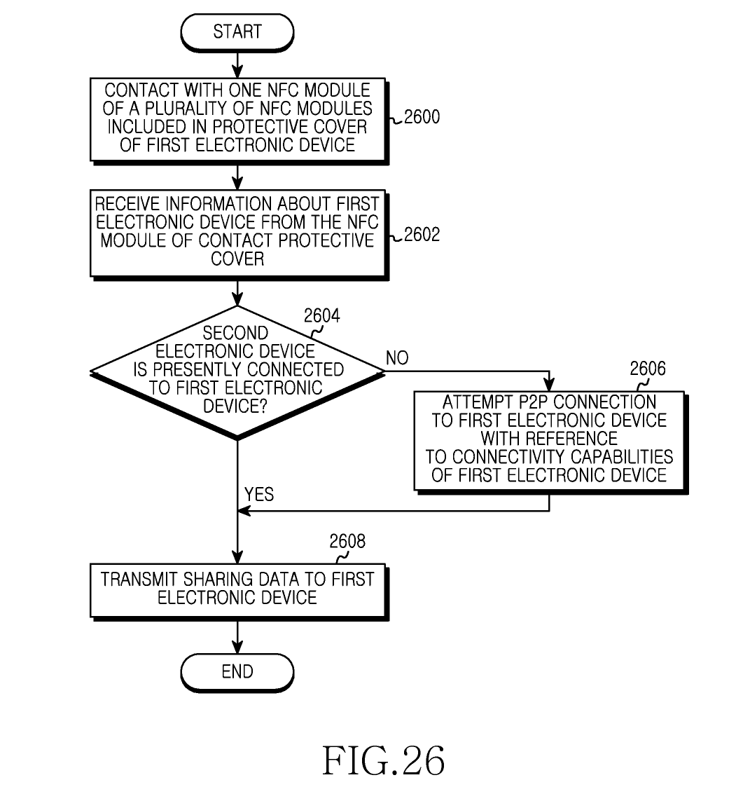

FIG. 26 is a flowchart illustrating an operation of a second electronic device according to an embodiment of the present invention.

Referring to FIG. 26, the second electronic device contacts with one NFC module of a plurality of NFC modules included in a protective cover in step 2600. For example, as shown in FIG. 5 or 6, a second NFC module (i.e., NFC reader) of the second electronic device contacts with one of a plurality of NFC modules (i.e., NFC tag) included in the protective cover. However, the communication module is not limited to an NFC module, and a Bluetooth direct communication method or a Wi-Fi direct communication method for short range communication may be used.

The second electronic device receives information about the first electronic device from the NFC module of the protective cover in step 2602. The information about the first electronic device may include unique identification information, information about connectivity capabilities, or an action code corresponding to a corresponding operation (e.g., screen sharing, P2P communication connection) of the first electronic device. For example, as shown in FIGS. 12A-12C and 13A-13B, the information about the first electronic device is recoded in each of NFC modules of the protective cover.

The second electronic device determines whether the second electronic device is currently connected to the first electronic device in step 2604. If the second electronic device is currently connected to the first electronic device, the second electronic device transmits sharing data to the first electronic device according to the information about the first electronic device in step 2608. For example, as shown in FIGS. 8A-8C, the second electronic device selects a plurality of pictures and transmits the plurality of pictures to the first electronic device; as shown in FIG. 9, the second electronic device synchronizes a screen of the first electronic device and a screen of the second electronic device and shares the screen of the second electronic device.

If the second electronic device is not currently connected to the first electronic device, the second electronic device attempts a P2P connection to the first electronic device with reference to connectivity capabilities of the first electronic device in step 2606, and when a P2P connection to the first electronic device is succeeded, the process continues to step 2608.

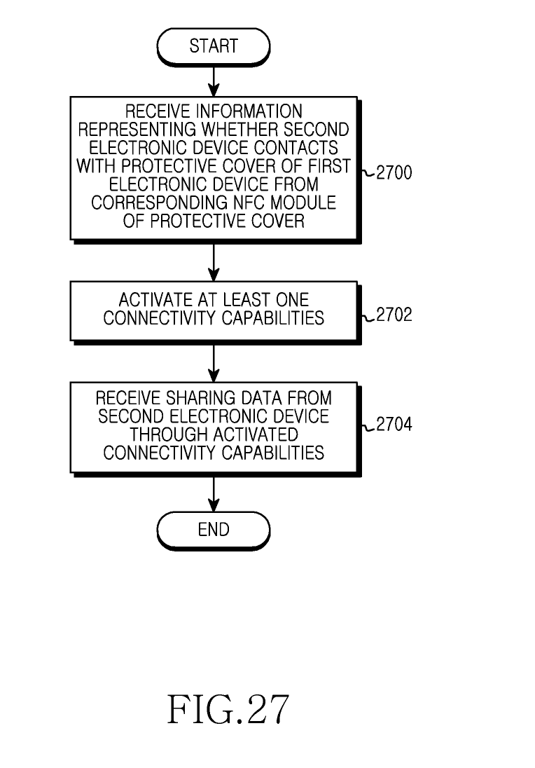

FIG. 27 is a flowchart illustrating an operation of a first electronic device according to an embodiment of the present invention.

Referring to FIG. 27, the first electronic device receives information representing whether the second electronic device contacts with a protective cover from a corresponding NFC module of the protective cover in step 2700.

The first electronic device activates at least one of connectivity capabilities in step 2702, and receives sharing data from the second electronic device through the activated at least one of connectivity capabilities in step 2704.

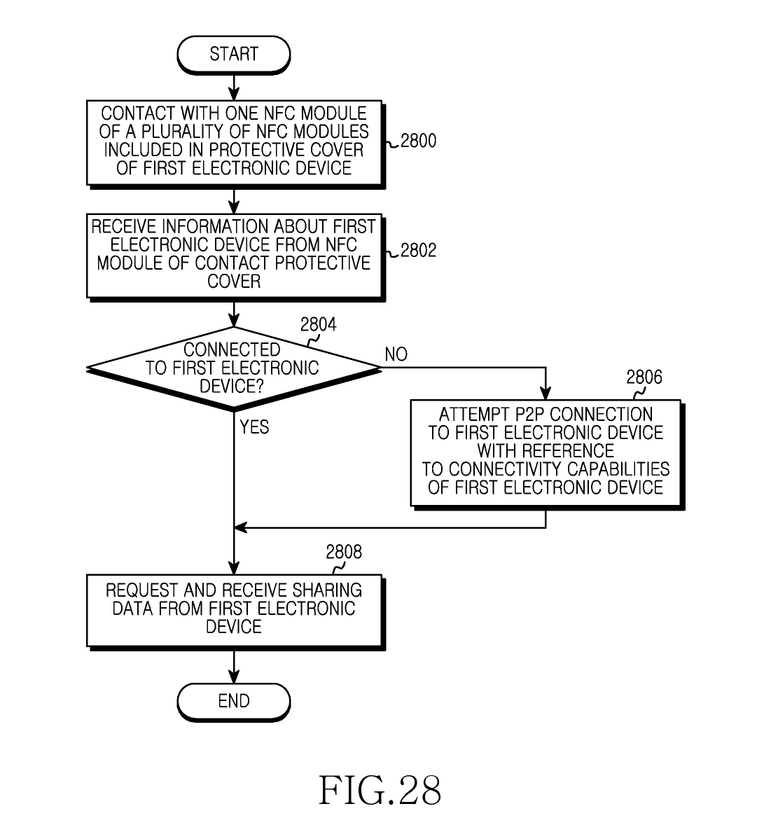

FIG. 28 is a flowchart illustrating an operation of a second electronic device according to an embodiment of the present invention.

Referring to FIG. 28, the second electronic device contacts with one NFC module of a plurality of NFC modules included in a protective cover in step 2800. For example, as shown in FIG. 5 or 6, a second NFC module (i.e., NFC reader) of the second electronic device contacts with one of a plurality of NFC modules (i.e., NFC tag) included in the protective cover. However, the communication module is not limited to an NFC module, and a Bluetooth communication method or a Wi-Fi direct communication method for short range communication may be used.

The second electronic device receives information about the first electronic device from the NFC module of the protective cover in step 2802. The information about the first electronic device may include unique identification information, information about connectivity capabilities, or an action code corresponding to a corresponding operation (e.g., screen sharing, P2P communication connection) of the first electronic device. For example, as shown in FIGS. 12A-12C and 13A-13B, the information about the first electronic device is recoded in each of NFC modules of the protective cover.

The second electronic device determines whether the second electronic device is currently connected to the first electronic device in step 2804. If the second electronic device is currently connected to the first electronic device, the second electronic device requests and receives sharing data from the first electronic device according to the information about the first electronic device in step 2808. For example, as shown in FIGS. 10A-10C, the second electronic device receives a plurality of pictures selected by the first electronic device; as shown in FIGS. 11A-11C, the second electronic device synchronizes a screen of the first electronic device and a screen of the second electronic device and shares the screen of the second electronic device.

If the second electronic device is not currently connected to the first electronic device, the second electronic device attempts a P2P connection to the first electronic device with reference to connectivity capabilities of the first electronic device in step 2806, and when a P2P connection to the first electronic device is succeeded, the process continues to step 2808.

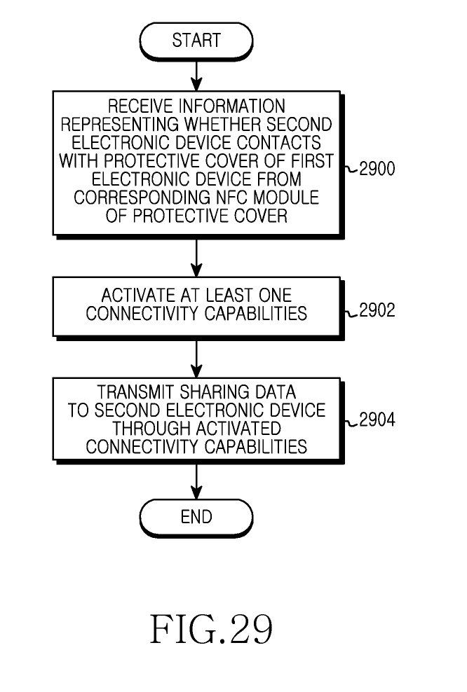

FIG. 29 is a flowchart illustrating an operation of a first electronic device according to an embodiment of the present invention.

Referring to FIG. 29, the first electronic device receives information representing whether a second electronic device contacts with a protective cover from a corresponding NFC module of the protective cover in step 2900.

The first electronic device activates at least one of connectivity capabilities in step 2902, and transmits sharing data in response to a sharing request of the second electronic device through the activated at least one of connectivity capabilities in step 2904.

An electronic device according to the present invention may be a device including a communication function. For example, the electronic device may be at least one or a combination of various devices such as a smart phone, a tablet Personal Computer (PC), a mobile phone, a video phone, an e-book reader, a desktop PC, a laptop PC, a Netbook computer, a Personal Digital Assistant (PDA), a Portable Multimedia Player (PMP), a Moving Picture Experts Group layer-3 (MP3) player, a mobile medical equipment, an electronic bracelet, an electronic necklace, electronic accessory, a camera, a wearable device, an electronic clock, a wrist watch, a smart white appliance (e.g., a refrigerator, an air conditioner, a vacuum cleaner, an artificial intelligence robot, a television, a Digital Video disk (DVD) player, an audio device, an oven, a microwave oven, a washing machine, an air cleaner, and an electronic frame), various medical equipments (e.g., a Magnetic Resonance Angiography (MRA) device, a Magnetic Resonance Imaging (MRI) device, a Computed Tomography (CT) device, a scanning machine, and a ultrasonic wave device), a navigation device, a Global Positioning System (GPS) receiver, an Event Data Recorder (EDR), a Flight Data Recorder (FDR), a set-top box, a television box (e.g., Samsung HomeSync™, Apple TV™, or Google TV™), an electronic dictionary, a vehicle infotainment device, an electronic equipment for ship (e.g., a navigation device for ship and a gyro compass), avionics, a security device, electronic clothing, an electronic key, a camcorder, game consoles, a Head-Mounted Display (HMD), a flat panel display device, an electronic album, a portion of furniture or a building/structure including a communication function, an electronic board, an electronic signature receiving device, or a projector. An electronic device according to the present invention is not limited to the foregoing devices.

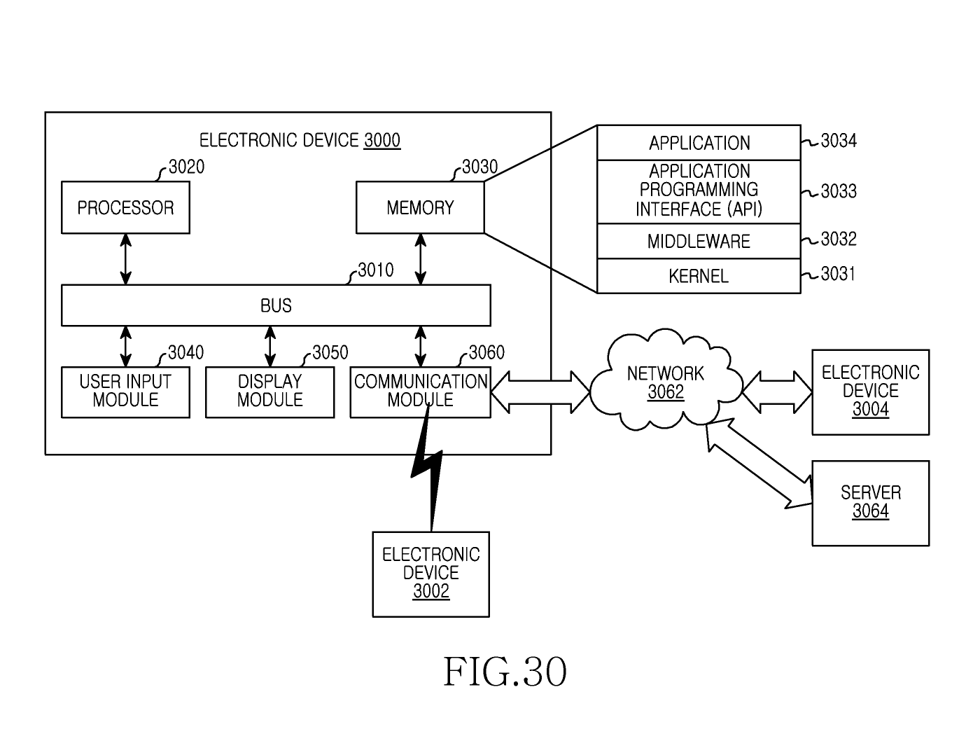

FIG. 30 is a block diagram illustrating a configuration of an electronic device according to an embodiment of the present invention of the present invention.

Referring to FIG. 30, an electronic device 3000 includes a bus 3010, a processor 3020, a memory 3030, a user input module 3040, a display module 3050, or a communication module 3060.

The bus 3010 is a circuit that connects the foregoing elements and that transfers communication information (e.g., a control message) between the foregoing elements.

The processor 3020 receives an instruction from the foregoing other elements (e.g., the memory 3030, the user input module 3040, the display module 3050, and the communication module 3060) through, for example, the bus 3010, decodes the received instruction, and executes an operation or a data processing according to the decoded instruction.

The memory 3030 stores an instruction or data received from the processor 3020 or other elements (e.g., the user input module 3040, the display module 3050, and the communication module 3060) or generated by the processor 3020 or other elements. The memory 3030 may include programming modules such as a kernel 3031, middleware 3032, an application programming interface (API) 3033, or an application 3034. The foregoing each programming module may be formed with software, firmware, hardware, or a combination of at least two thereof.

The kernel 3031 controls or manages system resources (e.g., the bus 3010, the processor 3020, or the memory 3030) used for executing an operation or a function implemented in the remaining programming modules, for example, the middleware 3032, the API 3033, or the application 3034. Further, the kernel 3031 provides an interface that accesses to an individual element of the electronic device 3000 in the middleware 3032, the API 3033, or the application 3034 to control or manage the individual element.

The middleware 3032 functions as an intermediary that enables the API 3033 or the application 3034 to communicate with the kernel 3031 to transmit and receive data. Further, the middleware 3032 performs load balancing of work requests received from the plurality of applications 3034 using a method of assigning a priority about using a system resource (e.g., the bus 3010, the processor 3020, or the memory 3030) of the electronic device 3000 in, for example, at least one application of the plurality of applications 3034.

The API 3033 is an interface in which the application 3034 can control a function in which the kernel 3031 or the middleware 3032 provides and may include at least one interface or function for, for example, file control, window control, image processing, or character control.

For example, the user input module 3040 receives an input of an instruction or data from the user to transfer the instruction or the data to the processor 3020 or the memory 3030 through the bus 3010. The display module 3050 may display a picture, an image, or data to the user.

The communication module 3060 sets up communication between the electronic device 3000 and another electronic device 3002. The communication module 3060 supports a predetermined short range communication protocol (e.g., Wireless Fidelity (WiFi), Bluetooth (BT), NFC, or communication of a predetermined network 3062 (e.g., Internet, a Local Area Network (LAN), a Wide Area Network (WAN), a telecommunication network, a cellular network, a satellite network, or Plain Old Telephone Service (POTS)). Each electronic device 3004 may be the same (e.g., the same type) device as the electronic device 3000 or may be a device different (e.g., different type) from the electronic device 3000.

A programming module of the memory 3030 may include an Operation system (OS) implemented with hardware to control a resource related to an electronic device (e.g., the electronic device 3000) or various applications driven on an OS. For example, the OS may be Android, iOS, Windows, Symbian, Tizen, or Bada.

At least a portion of the programming module may be implemented with an instruction stored at computer-readable storage media. When the instruction is executed by at least one processor, the at least one processor may perform a function corresponding to the instruction. The computer-readable storage media may be, for example, the memory 3030. At least a portion of the programming module may be implemented (e.g., executed) by, for example, the processor 3020. At least a portion of the programming module may include, for example, a module, a program, a routine, sets of instructions, or a process for performing at least one function.

Names of constituent elements of a programming module (e.g., the programming module) according to an embodiment of the present invention may be changed according to a kind of an operation system. Further, a programming module according to an embodiment of the present invention may include at least one of the foregoing constituent elements, may omit some constituent elements, or may further include additional other constituent elements.

As described above, an embodiment of the present invention may provide a connection and an interaction between distinguished electronic devices using a protective cover including at least one NFC module in addition to a protecting function of the protective cover.

Further, by using an inner surface of a protective cover in a diary form, the protective cover may be widely used.

While the present invention has been particularly shown and described with reference to embodiments thereof, it will be understood by those skilled in the art that various changes in form and details may be made therein without departing from the spirit and scope of the present invention as defined by the appended claims and their equivalents.

What is claimed is:

1. A method of operating a second electronic device for an interaction between electronic devices, the method comprising:
detecting a communication module of at least one communication module included in a protective cover, the protective cover being used to protect a first electronic device;
receiving information about the first electronic device from the detected communication module of the protective cover; and
performing an interaction with the first electronic device based on the information about the first electronic device.

2. The method of claim 1, wherein the information about the first electronic device comprises at least one of unique identification information of the first electronic device, connectivity capabilities information of the first electronic device, or an action code for an interaction between electronic devices.

3. The method of claim 1, wherein the communication module comprises a Near Field Communication (NFC) module.

4. The method of claim 1, wherein performing the interaction comprises:
displaying communication methods which the first electronic device can use;
selecting one of the communication methods; and
attempting a communication connection with the first electronic device based on the selected communication method.

5. The method of claim 4, further comprising:
searching for, when the communication connection with the first electronic device was failed, another communication method which the first electronic device can use, using the information about the first electronic device; and
attempting, when the another communication method is found, another communication connection with the first electronic device using the found communication method.

6. The method of claim 5, further comprising displaying, when the another communication method is not found, a message instructing that it is necessary to activate at least one communication method of the first electronic device.

7. The method of claim 1, wherein performing the interaction comprises:
determining whether the second electronic device is connected to the first electronic device; and
transmitting, if it is determined that the second electronic device is connected to the first electronic device, shared data to the first electronic device.

8. The method of claim 7, further comprising attempting, if it is determined that the second electronic device is not connected to the first electronic device, a communication connection with the first electronic device with reference to at least one communication method of the first electronic device.

9. The method of claim 1, wherein performing an interaction comprises:
determining whether the second electronic device is connected to the first electronic device; and
requesting and receiving, if it is determined that the second electronic device is connected to the first electronic device, shared data from the first electronic device.

10. The method of claim 9, further comprising attempting, if it is determined that the second electronic device is not connected to the first electronic device, a communication connection with the first electronic device with reference to at least one communication method of the first electronic device.

11. A method of operating a first electronic device for an interaction between electronic devices, the method comprising:
receiving information representing whether a second electronic device contacts with a protective cover from a communication module of at least one communication module included in the protective cover, the protective cover being used to protect the first electronic device; and
preparing an interaction with the second electronic device.

12. The method of claim 11, wherein the information about the first electronic device comprises at least one of unique identification information of the first electronic device, connectivity capabilities information of the first electronic device, or an action code for an interaction between electronic devices.

13. The method of claim 11, wherein preparing the interaction comprises:
activating at least one communication method for a communication connection with the second electronic device; and
attempting the communication connection with the second electronic device through the activated at least one communication method.

14. The method of claim 11, wherein preparing the interaction comprises:
activating at least one communication method for a communication connection with the second electronic device; and
receiving shared data from the second electronic device based on the activated at least one communication method.

15. The method of claim 11, wherein preparing the interaction comprises:
activating at least one communication method for a communication connection with the second electronic device; and
transmitting shared data to the second electronic device based on the activated at least one communication method.

16. The method of claim 11, wherein the communication module comprises a Near Field Communication (NFC) module.

17. A second electronic device for an interaction between electronic devices, the second electronic device comprising:
a processor configured to detect a communication module of at least one communication module included in a protective cover, the protective cover being used to protect a first electronic device, to receive information about the first electronic device from the detected communication module of the protective cover, and to perform an interaction with the first electronic device based on the information about the first electronic device.

18. The second electronic device of claim 17, wherein the information about the first electronic device comprises at least one of unique identification information of the first electronic device, connectivity capabilities information of the first electronic device, or an action code for an interaction between electronic devices.

19. The second electronic device of claim 17, wherein the communication module comprises a Near Field Communication (NFC) module.

20. The second electronic device of claim 17, wherein the processor is further configured to display communication methods which the first electronic device can use, to select one of the communication methods according to a user input, and to attempt a communication connection with the first electronic device based on the selected communication method.

21. The second electronic device of claim 20, wherein the processor is further configured to search for another communication method which the first electronic device can use using the information about the first electronic device, when the communication connection with the first electronic device is failed, and to attempt another communication connection with the first electronic device using the found communication method, when the another communication method is found.

22. The second electronic device of claim 21, wherein the processor is further configured to display a message instructing that it is necessary to activate at least one communication method of the first electronic device, when the another communication method is not found.

23. The second electronic device of claim 17, wherein the processor is further configured to determine whether the second electronic device is connected to the first electronic device, and to transmit shared data to the first electronic device, if it is determined that the second electronic device is connected to the first electronic device.

24. The second electronic device of claim 23, wherein the processor is further configured to attempt a communication connection with the first electronic device with reference to at least one communication method of the first electronic device, if it is determined that the second electronic device is not connected to the first electronic device.

25. The second electronic device of claim 17, wherein the processor is further configured to determine whether the second electronic device is connected to the first electronic device, and to request and receive shared data from the first electronic device, if it is determined that the second electronic device is connected to the first electronic device.

26. The second electronic device of claim 25, wherein the processor is further configured to attempt a communication connection with the first electronic device with reference to at least one communication method of the first electronic device, if it is determined that the second electronic device is not connected to the first electronic device.

27. A first electronic device for an interaction between electronic devices, the first electronic device comprising:
a processor configured to receive information representing whether a second electronic device contacts with a protective cover from at least one communication module of a plurality of communication modules included in the protective cover, the protective cover being used to protect a first electronic device, and to prepare an interaction with the second electronic device.

28. The first electronic device of claim 27, wherein the information about the first electronic device comprises at least one of unique identification information of the first electronic device, connectivity capabilities information of the first electronic device, or an action code for an interaction between electronic devices.

29. The first electronic device of claim 27, wherein the processor is further configured to activate at least one communication method for a communication connection with the second electronic device, and to attempt the communication connection with the second electronic device through the activated at least one communication method.

30. The first electronic device of claim 27, wherein the processor is further configured to activate at least one communication method for a communication connection with the second electronic device, and to receive shared data from the second electronic device based on the activated at least one communication method.

31. The first electronic device of claim 27, wherein the processor is further configured to activate at least one communication method for a communication connection with the second electronic device, and to transmit shared data to the second electronic device based on the activated at least one communication method.

32. The first electronic device of claim 27, wherein the communication module comprises a Near Field Communication (NFC) module.
